(19) United States
(12) Patent Application Publication
(10) Pub. No.: US 2026/0177382 A1
(43) Pub. Date: Jun. 25, 2026

(54) LINE LASER ASSEMBLY WITH ACTIVE LEVELING

(71) Applicant: Stanley Black & Decker Inc., New Britain, CT (US)

(72) Inventors: JB Ring, Vienna, VA (US); Vishnu Damacharla, Scottsdale, AZ (US); Vea Hernandez, Damascus, MD (US); Kiran Nagaraju, Farmington, CT (US); Sergey Voloshinov, Brimfield, MA (US); Stephen Nichols, Madison, CT (US); Mikael C. Schmittdiel, Towson, MD (US); Jonathan Bellamy, Windsor, CT (US); Michael W. Bauer, Baltimore, MD (US)

(21) Appl. No.: 19/425,945

(22) Filed: Dec. 18, 2025

Related U.S. Application Data
(60) Provisional application No. 63/736,779, filed on Dec. 20, 2024.

(51) Int. Cl. G01C 15/00

(52) U.S. Cl. CPC G01C 15/004

(57) ABSTRACT

A laser leveling apparatus includes a housing, a first laser generator, and a second laser generator such that the laser leveling apparatus is reorientable between an upright position, in which the first laser generator is oriented for generating a horizontal line when activated and in which the second laser generator is oriented for generating a first vertical line when activated, and a side lying position, in which the first laser generator is oriented for producing a second vertical line when activated and in which the second laser generator is oriented for producing the first vertical line when activated. The laser leveling apparatus further includes an active leveling platform assembly having a plurality of sensor assemblies in electronic communication with a plurality of motor assemblies for tilting an upper frame assembly supporting the first laser generator and the second laser generator about a lower frame assembly about three perpendicular axes.

### CROSS-REFERENCE TO RELATED APPLICATION

The present application claims priority to U.S. Provisional Patent Application No. 63/736,779, filed on Dec. 20, 2024.

### INCORPORATION BY REFERENCE

The disclosure of U.S. Provisional Patent Application No. 63/736,779, filed on Dec. 20, 2024, is hereby incorporated by reference for all purposes as if set forth in its entirety.

### TECHNICAL FIELD

The present application relates to laser level assemblies, and leveling features for such laser level assemblies.

### BACKGROUND

Laser level assemblies project a beam of light, directly or indirectly, onto a surface in order to provide a guide line along which various working operations can be compared, for example, in commercial or home construction, home improvement projects, craft hobbies, and other applications, to name a few.

In order to provide an effective guide line, it is desirable for a projected beam of light to be leveled with respect to a frame of reference. However, there remains a need for leveling assemblies that are compact, accurate, and that can adapt to a variety of use cases.

### SUMMARY

According to one aspect, the disclosure is generally directed to a laser leveling apparatus, the laser leveling apparatus comprising a housing, a first laser generator at least partially received in the housing and configured to project a first laser line when activated, a second laser generator at least partially received in the housing and configured to project a second laser line perpendicular to the first laser line when activated such that the laser leveling apparatus is reorientable between an upright position, in which the first laser generator is oriented for generating a horizontal line when activated and in which the second laser generator is oriented for generating a first vertical line when activated, and a side lying position, in which the first laser generator is oriented for producing a second vertical line when activated and in which the second laser generator is oriented for producing the first vertical line when activated. The laser leveling apparatus further comprises an active leveling platform assembly positioned in an interior of the housing, the active leveling platform assembly comprising an upper frame assembly pivotably mounted to a lower frame assembly, the first laser generator and the second laser generator supported on the upper frame assembly, a plurality of motor assemblies operably coupled to the upper frame assembly, and a respective sensor assembly of a plurality of sensor assemblies in electronic communication with a respective motor assembly of the plurality of motor assemblies. The laser leveling apparatus further comprises control circuitry configured to activate the plurality of motor assemblies to tilt the upper frame assembly relative to the lower frame assembly about a first axis, a second axis, and a third axis based on one or more signals from the plurality of sensor assemblies, the first axis is perpendicular to each of the second axis and the third axis, and the second axis is perpendicular to the third axis.

According to some example implementations, the plurality of motor assemblies comprises a first motor assembly operably coupled to the upper frame assembly, a second motor assembly operably coupled to the upper frame assembly, and a third motor assembly operably coupled to the upper frame assembly.

According to some example implementations, the plurality of sensor assemblies comprises a first sensor assembly in electronic communication with the first motor assembly, a second sensor assembly in electronic communication with the second motor assembly, and a third sensor assembly in electronic communication with the third motor assembly.

According to some example implementations, the control circuitry is configured to activate the first motor assembly to tilt the upper frame assembly relative to the lower frame assembly about the first axis based on one or more signals from the first sensor assembly, activate the second motor assembly to tilt the upper frame assembly relative to the lower frame assembly about the second axis based on one or more signals from the second sensor assembly, and activate the third motor assembly to tilt the upper frame assembly relative to the lower frame assembly about the third axis based on one or more signals from the third sensor assembly.

According to some example implementations, the first laser generator and the second laser generator each comprise a respective line laser module.

According to some example implementations, the control circuitry is configured to drive each of the first motor assembly and the second motor assembly along a direction parallel to the third axis to tilt the upper frame assembly relative to the respective first axis and second axis.

According to some example implementations, the control circuitry is configured to drive the third motor assembly along a direction parallel to one of the first axis and the second axis to tilt the upper frame assembly about the third axis.

According to some example implementations, the upper frame assembly of the active leveling platform assembly is pivotably mounted to the lower frame assembly of the active leveling platform assembly on a ball joint.

According to some example implementations, at least one of the first sensor assembly, the second sensor assembly, and the third sensor assembly comprises a bubble level.

According to another aspect, the disclosure is generally directed to an active leveling platform assembly for a laser leveling apparatus, the active leveling platform assembly comprising an upper frame assembly pivotably mounted to a lower frame assembly, a first laser generator and a second laser generator supported on the upper frame assembly, a plurality of motor assemblies operably coupled to the upper frame assembly, and a respective sensor assembly of a plurality of sensor assemblies in electronic communication with a respective motor assembly of the plurality of motor assemblies. The laser leveling apparatus further comprises control circuitry configured to activate the plurality of motor assemblies to tilt the upper frame assembly relative to the lower frame assembly about a first axis, a second axis, and a third axis based on one or more signals from the plurality of sensor assemblies, the first axis is perpendicular to each of the second axis and the third axis, and the second axis is perpendicular to the third axis.

According to some example implementations, the plurality of motor assemblies comprises a first motor assembly operably coupled to the upper frame assembly, a second motor assembly operably coupled to the upper frame assembly, and a third motor assembly operably coupled to the upper frame assembly.

According to some example implementations, the plurality of sensor assemblies comprises a first sensor assembly in electronic communication with the first motor assembly, a second sensor assembly in electronic communication with the second motor assembly, and a third sensor assembly in electronic communication with the third motor assembly.

According to some example implementations, the control circuitry is configured to activate the first motor assembly to tilt the upper frame assembly relative to the lower frame assembly about the first axis based on one or more signals from the first sensor assembly, activate the second motor assembly to tilt the upper frame assembly relative to the lower frame assembly about the second axis based on one or more signals from the second sensor assembly, and activate the third motor assembly to tilt the upper frame assembly relative to the lower frame assembly about the third axis based on one or more signals from the third sensor assembly.

According to some example implementations, the first laser generator and the second laser generator each comprise a respective line laser module.

According to some example implementations, the control circuitry is configured to drive each of the first motor assembly and the second motor assembly along a direction parallel to the third axis to tilt the upper frame assembly relative to the respective first axis and second axis.

According to some example implementations, the control circuitry is configured to drive the third motor assembly along a direction parallel to one of the first axis and the second axis to tilt the upper frame assembly about the third axis.

According to some example implementations, the upper frame assembly of the active leveling platform assembly is pivotably mounted to the lower frame assembly of the active leveling platform assembly on a ball joint.

According to some example implementations, at least one of the first sensor assembly, the second sensor assembly, and the third sensor assembly comprises a bubble level.

According to another aspect, the disclosure is generally directed to a method of assembling a laser leveling apparatus, the method comprising obtaining a housing, obtaining a first laser generator, obtaining a second laser generator, and positioning the first laser generator and the second laser generator relative to the housing such that the laser leveling apparatus is reorientable between an upright position, in which the first laser generator is oriented for generating a horizontal line when activated and in which the second laser generator is oriented for generating a first vertical line when activated, and a side lying position, in which the first laser generator is oriented for producing a second vertical line when activated and in which the second laser generator is oriented for producing the first vertical line when activated. The method further comprises pivotably mounting an upper frame assembly to a lower frame assembly, mounting the first laser generator on the upper frame assembly, mounting the second laser generator on the upper frame assembly, operably coupling a plurality of motor assemblies to the upper frame assembly, and positioning a respective sensor assembly of a plurality of sensor assemblies in electronic communication with a respective motor assembly of the plurality of motor assemblies. The method further comprises placing plurality of motor assemblies and the plurality of sensor assemblies in electronic communication with control circuitry such that the plurality of motor assemblies are configured to tilt the upper frame assembly relative to the lower frame assembly about a first axis, a second axis, and a third axis based on one or more signals from the plurality of sensor assemblies, the first axis is perpendicular to each of the second axis and the third axis, and the second axis is perpendicular to the third axis.

According to some example implementations, the plurality of motor assemblies comprises a first motor assembly operably coupled to the upper frame assembly, a second motor assembly operably coupled to the upper frame assembly, and a third motor assembly operably coupled to the upper frame assembly.

According to some example implementations, the plurality of sensor assemblies comprises a first sensor assembly in electronic communication with the first motor assembly, a second sensor assembly in electronic communication with the second motor assembly, and a third sensor assembly in electronic communication with the third motor assembly.

According to some example implementations, the control circuitry is configured to activate the first motor assembly to tilt the upper frame assembly relative to the lower frame assembly about the first axis based on one or more signals from the first sensor assembly, activate the second motor assembly to tilt the upper frame assembly relative to the lower frame assembly about the second axis based on one or more signals from the second sensor assembly, and activate the third motor assembly to tilt the upper frame assembly relative to the lower frame assembly about the third axis based on one or more signals from the third sensor assembly.

According to some example implementations, the first laser generator and the second laser generator each comprise a respective line laser module.

According to some example implementations, the control circuitry is configured to drive each of the first motor assembly and the second motor assembly along a direction parallel to the third axis to tilt the upper frame assembly relative to the respective first axis and second axis.

According to some example implementations, the control circuitry is configured to drive the third motor assembly along a direction parallel to one of the first axis and the second axis to tilt the upper frame assembly about the third axis.

According to some example implementations, the upper frame assembly of the active leveling platform assembly is pivotably mounted to the lower frame assembly of the active leveling platform assembly on a ball joint.

According to some example implementations, at least one of the first sensor assembly, the second sensor assembly, and the third sensor assembly comprises a bubble level.

Those skilled in the art will appreciate the above stated advantages and other advantages and benefits of various additional embodiments reading the following detailed description of the embodiments with reference to the below-listed drawing figures.

### BRIEF DESCRIPTION OF THE DRAWINGS

According to common practice, the various features of the drawings discussed below are not necessarily drawn to scale. Dimensions of various features and elements in the drawings may be expanded or reduced to more clearly illustrate the embodiments of the disclosure.

FIG. 1 is a perspective view of a laser level assembly according to exemplary embodiments of the disclosure in a first orientation.

FIG. 2 is a perspective view of a laser level assembly according to exemplary embodiments of the disclosure in a second orientation.

FIG. 3 is a perspective view of an active leveling platform assembly for a laser level assembly according to exemplary embodiments of the disclosure.

FIG. 4 is another perspective view of the active leveling platform assembly of FIG. 3.

FIG. 5 is another perspective view of the active leveling platform assembly of FIG. 3.

FIG. 6 is another perspective view of the active leveling platform assembly of FIG. 3.

FIG. 7 is a perspective view of a ball joint for an active leveling platform assembly according to exemplary embodiments of the disclosure, shown in isolation for clarity of illustration.

FIG. 8 is a perspective view of a leveling platform apparatus of an active leveling platform assembly according to exemplary embodiments of the disclosure.

FIG. 9 is another perspective view of the leveling platform apparatus of FIG. 8.

FIG. 10 is another perspective view of the leveling platform apparatus of FIG. 8.

FIG. 11 is a schematic diagram of a sensor assembly of a laser level assembly according to exemplary embodiments of the disclosure.

FIG. 12 is a perspective view of a compensation apparatus of an active leveling platform assembly according to exemplary embodiments of the present disclosure.

FIG. 13 is another perspective view of the compensation apparatus of FIG. 12.

FIG. 14 is another perspective view of the compensation apparatus of FIG. 12.

FIG. 15 is a schematic diagram of a laser level assembly according to exemplary embodiments of the present disclosure.

FIG. 16 is a perspective view of a handheld I/O device for use with a laser level assembly according to exemplary embodiments of the present disclosure.

FIG. 17 is a block diagram of a process of active leveling for a laser level assembly according to exemplary embodiments of the disclosure.

FIG. 18 is a flowchart of one or more processes for active leveling of a laser level assembly according to exemplary embodiments of the disclosure.

FIG. 19A is a continuation of the flowchart of FIG. 18.

FIG. 19B is a flowchart of selected steps of FIG. 19A.

FIG. 20A is a continuation of the flowchart of FIG. 18.

FIG. 20B is a flowchart of selected steps of FIG. 20A.

FIG. 21A is a continuation of the flowchart of FIG. 18.

FIG. 21B is a flowchart of selected steps of FIG. 21A.

FIG. 22 is a schematic diagram of an electronics system compatible with laser level assemblies according to exemplary embodiments of the present disclosure.

Corresponding parts are designated by corresponding reference numbers throughout the drawings.

### DETAILED DESCRIPTION OF THE EXEMPLARY EMBODIMENTS

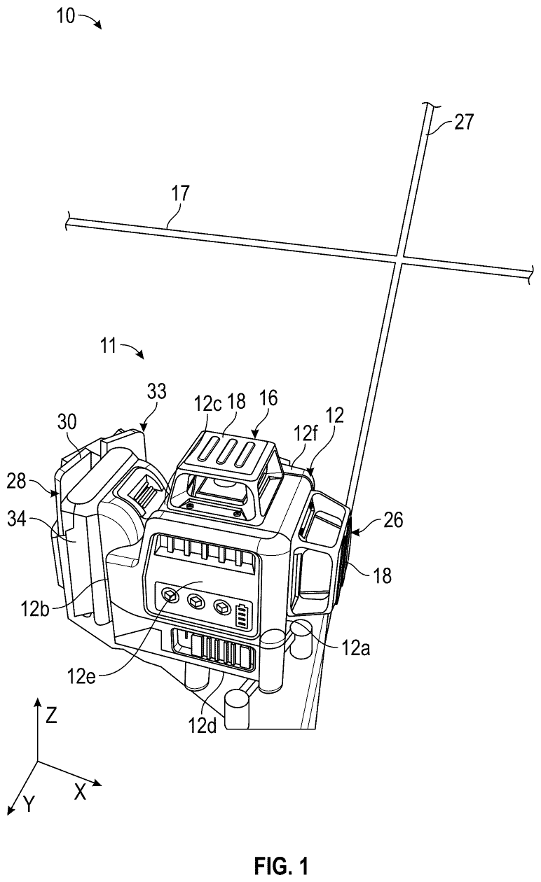

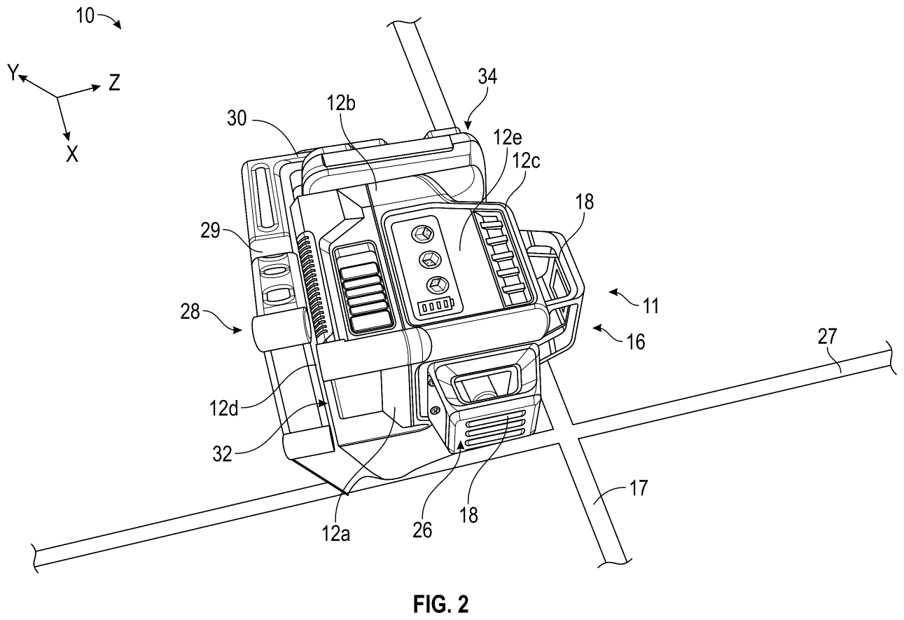

Referring to FIGS. 1 and 2, an exemplary embodiment of a laser level assembly 10 is illustrated according to an exemplary embodiment of the disclosure. As described further herein, the laser level assembly 10 is repositionable between two orientations: a first or upright orientation, shown in FIG. 1, and a second or side laying orientation, shown in FIG. 2.

As described herein, the laser level assembly 10 may be oriented about three axes: an X-axis (broadly, “first axis”), a Y-axis (broadly, “second axis”), and a Z-axis (broadly, “third axis”). The X-axis defines the laser level assembly 10 generally in the into-page and out-of-page directions in the first orientation of FIG. 1. The Y-axis defines the laser level assembly 10 generally in the left and right directions in the orientation of FIG. 1, and the Z-axis defines the laser level assembly 10 generally in the up and down directions in the orientation of FIG. 1.

In the aforementioned arrangement, the X-axis is perpendicular to each of the Y-axis and the Z-axis, the Y-axis is perpendicular to each of the X-axis and the Z-axis, and the Z-axis is perpendicular to each of the X-axis and the Y-axis. It will be understood that the laser level assembly 10 can be differently oriented with respect to a set of coordinate axes. It will further be understood that the aforementioned axes can be reoriented between the first configuration and the second configuration of the laser level assembly 10.

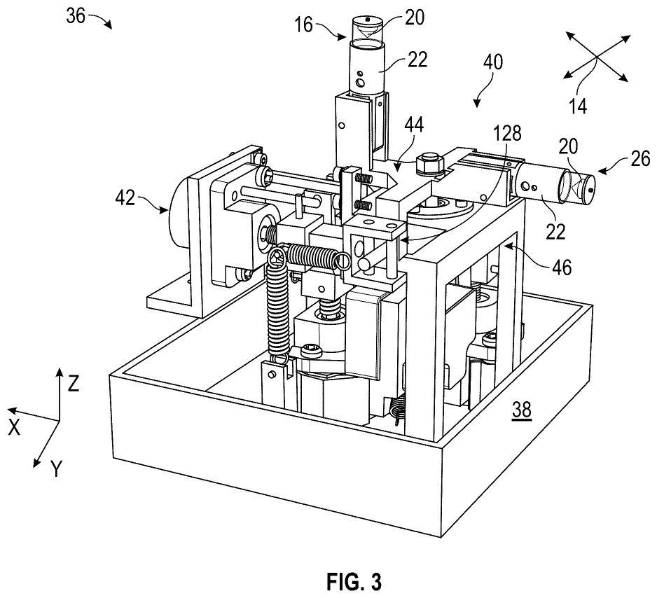

As shown, the laser level assembly 10 can include a laser level apparatus 11 having a housing 12 that can extend at least partially around an interior 14 (shown schematically in FIG. 3) therein within which one or more components of the laser level assembly 10 can be received.

In this regard, the housing 12 can have an at least partially hollow construction, and can be formed of one or more of composite, metallic, and polymeric materials, for example, an injection molded plastic. In some embodiments, the housing 12 can be formed from one or more mated components or housing shells that can be, for example, sealed or welded, mechanically coupled, etc.

In this regard, the housing 12 of the laser level assembly 10 can generally define a front end 12a, a rear end 12b, a top end 12c, a bottom end 12d, a first side 12e, and a second side 12f.

A plurality of laser projectors can be supported on at least partially extending through the housing 12 at locations at which a respective plurality of lasers can be transmitted from the laser level apparatus 11 toward one or more target surfaces, e.g., walls, floors, work surfaces, etc.

In the illustrated embodiment, a first laser projector (broadly, “first laser projector”) 16 can be supported extending upwardly from the top end 12c housing 12 when the laser level assembly 10 is in the first orientation. The first laser projector 16 can be at least partially received within a frame 18 that at least partially defines one or more openings or slots therealong to allow one or more laser beams to pass. The first laser projector 16 can include a reflector 20 at least partially received within the frame 18, and a laser module 22 supported adjacent the reflector 20 so as to direct one or more laser beams into or onto the reflector 20 when energized. In some embodiments, the frame 18 can be a portion of the housing 12 of the laser level apparatus 11, or the frame 18 can be a separate component attached to the housing 12.

The laser module 22 can be an element capable of receiving electrical power and producing one or more laser beams. The laser module 22 can include one or more laser diodes, or can additionally or alternatively include one or more different laser producing elements. In some embodiments, the laser module 22 can be a line laser module.

The reflector 20, as described herein, can be an at least partially reflective element, e.g., having one or more curved and/or polished surfaces so as to be configured to at least partially receive one or more laser beams thereon and produce a projected laser line 17 or section thereof emanating outwardly from the reflector 20, through respective portions of the frame 18, and toward a target surface. In the illustrated embodiment, the laser line 17 can be a portion of an annular beam or plane of light emanating from the reflector 20 that is visible on a target surface. In the first orientation of the laser level assembly 10, the laser line 17 can be a horizontal or level line.

It will be understood that a reflector 20 having a different configuration can be provided without departing from the disclosure. In some embodiments, one or more lenses can be provided that can refract one or more laser beams so as to provide one or more desirable directional and/or optical properties thereto.

Similarly, a second laser projector (broadly, “second laser projector”) 26 can be supported extending outwardly from the front end 12a of the housing 12 when the laser level assembly 10 is in the first orientation. The second laser projector 26 can be at least partially received within a frame 18 and can include a reflector 20 at least partially received within the frame 18, and a laser module 22 supported adjacent the reflector 20 so as to direct one or more laser beams into or onto the reflector 20 when energized.

In this regard, the second laser projector 26 can produce a resultant laser line 27 or section thereof emanating outwardly from the respective reflector 20 in a manner similar to that described above with respect to the first projector 16, except that the orientations of the respective laser projectors 16, 26 is such that the resulting laser lines 17, 27 extend along generally perpendicular planes, e.g., an X-Y plane formed by the X-axis and Y-axis, and a Y-Z plane formed by the Y-axis and the Z-axis, respectively.

In this regard, the laser generators 16, 26 can be provided to provide two ring-like beams so as to have a 2×360, e.g., two laser generators each with a generally 360 degree field of projection, configuration of the laser level assembly 10. It will be understood that the laser level assembly 10 could have a different laser generator configuration without departing from the disclosure, for example, 1×360, 3×360, 1×180, 2×180, 3×180, etc. In some embodiments, laser generators can be provided arranged adjacent to one another, e.g., such that a laser projector can include multiple laser modules in differing orientations, so as to provide a crossbeam laser configuration. In some example embodiments, a laser level may also project spots or a combination of spots and lines.

The housing 12 of the laser level apparatus 11, as shown, can be rotatably supported on a base 28 that can include a bottom wall 29 and a side wall 30 extending upwardly from the bottom wall 29 when the laser level assembly 10 is in the first orientation.

The base 28, as shown, can at least partially define a laser level assembly receiving space 32 and a battery receiving space 33 each at least partially defined between the bottom wall and the side wall 30.

The laser level assembly receiving space 32, as shown, can be configured and dimensioned to generally align with a bottom of the housing 12 of the laser level apparatus 11. In some embodiments, the bottom wall 29 of the base 27 can at least partially define one or more tracks, recesses, grooves, etc., such that a corresponding feature of the housing 12 of the laser level apparatus 11 can be received in such structure so as to allow for rotation/pivoting of the laser level apparatus 11 relative to the base 27.

The battery receiving space 33 can be configured to receive a battery pack 34 therein, which can be coupled to the laser level apparatus 11 to provide power thereto. In some embodiments, the battery 34 can be a removable, rechargeable battery pack with a housing extending at least partially around an interior thereof within which battery cell(s), electronics, and other components of the battery pack 34 can be held. While the battery pack 34 generally has the configuration of a lithium-ion (Li-ion) battery, it will be understood that the battery pack 34 could be a differently-configured compacted electrical energy storage device without departing from the disclosure. The battery pack 34 may be a power tool battery pack that can be removed from the laser level apparatus 11 and selectively engaged with various power tools of a power tool system such as a drill, a circular saw, and a random-orbit sander.

In this regard, the battery pack 34 can be configured for being releasably coupled to the laser level apparatus 11 for providing electrical power thereto, for example, through a series of electrical contacts/battery terminals and associated wiring and circuitry. As described further herein, the battery pack 34 can provide electrical power to the laser generators 16, 26, among other electrically-powered components of the laser level assembly 10. The battery receiving space 32 along the base 27 can thus be configured and dimensioned to provide sufficient clearance for the battery pack 34 to clear the side wall 30 when the laser level apparatus 11, to which the battery pack 34 can be releasably coupled, pivots or rotates about the base 27.

In view of the foregoing, the laser level assembly 10 can be oriented and manipulated according to a variety of use cases. In the upright orientation of the laser level assembly 10, the first laser projector 16 can project the laser line 17 generally horizontally from the perspective of a user so as to provide a level line, for example along generally upright surfaces relative to a floor on which the user is standing. The second laser projector 26 can thus project the laser line 27 generally vertically from the perspective of a user so as to provide a plumb line, for example, extending between a ceiling and the floor on which the user is standing. It will be understood that such lines can be provided in a variety of environments.

Furthermore, in the side laying orientation of the laser level assembly 10, the first laser projector 16 can project the laser line 17 generally vertically from the perspective of a user so as to provide a first plumb line, and the second laser projector 26 can thus project the laser line 27 generally vertically from the perspective of a user so as to provide a second plumb line that is transverse to the first plumb line.

In this regard, the laser level assembly 10 can be reorientable between the upright orientation, in which a horizontal line and a vertical line can be provided, and a side laying orientation, in which perpendicular vertical lines can be provided. Lines across three perpendicular axes can thus be provided by reorienting the laser level assembly 10 to make use of the two laser generators 16, 26 provided thereby. Accordingly, the laser level assembly 10 provides a versatile laser line generating device capable of providing guide lines along three parallel axes in a compact configuration that can include two laser generators 16, 26.

As described further herein, the versatility and reorientability of the laser level assembly 10 is such that it may be desirable to true, level, or otherwise realign the laser lines 16, 26 with regard to a frame of reference. In some embodiments, such frame of reference can be that in which a downward direction is determined by the influence of gravity. In this regard, the laser level assembly can be provided with active leveling features.

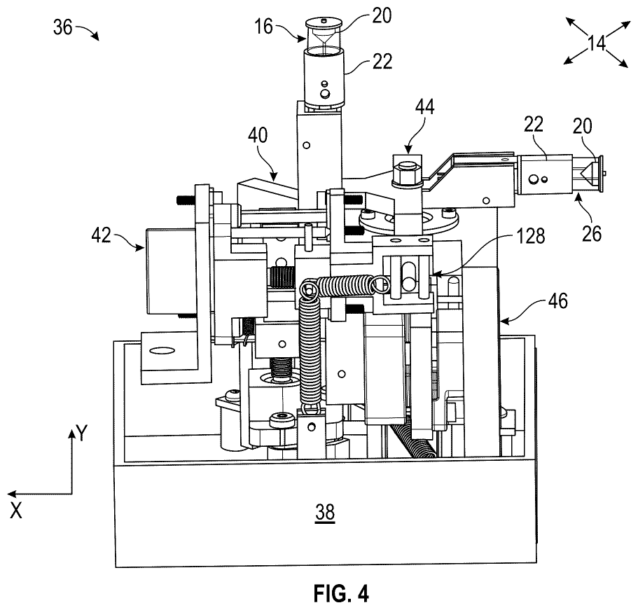

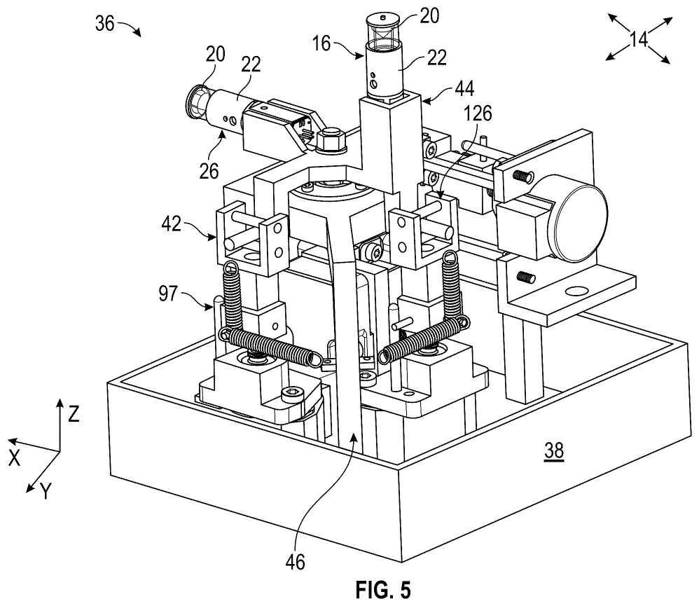

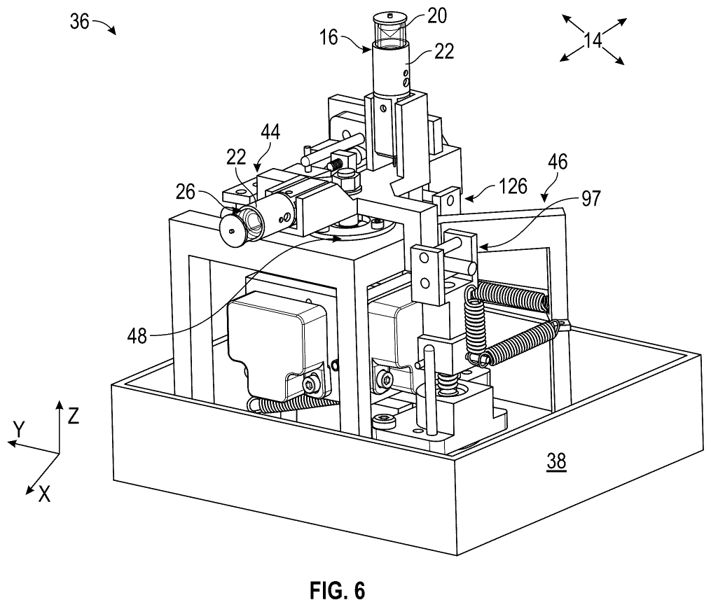

With additional reference to FIGS. 3-6, an active leveling platform assembly 36, on which the laser generators 16, 26 are supported, is schematically illustrated at least partially received within the interior 14 of the housing 12 of the laser leveling apparatus 11. The active leveling platform assembly 36 can include a base 38 that can at least partially receive the remainder thereof. In some embodiments, the base 38 can be supported on a portion of the housing 12 of the laser level apparatus 11. In other embodiments, the further components of the active leveling platform assembly 36 can be supported on the housing 12 of the laser leveling apparatus 11.

In the illustrated embodiment, the active leveling platform assembly 36 can include a leveling platform apparatus 40 and a compensation apparatus 42 at least partially supported in a recess at least partially defined by the base 38. In this regard, the leveling platform apparatus 40 and the compensation apparatus 42 can be sub-assemblies of the active leveling platform assembly 36.

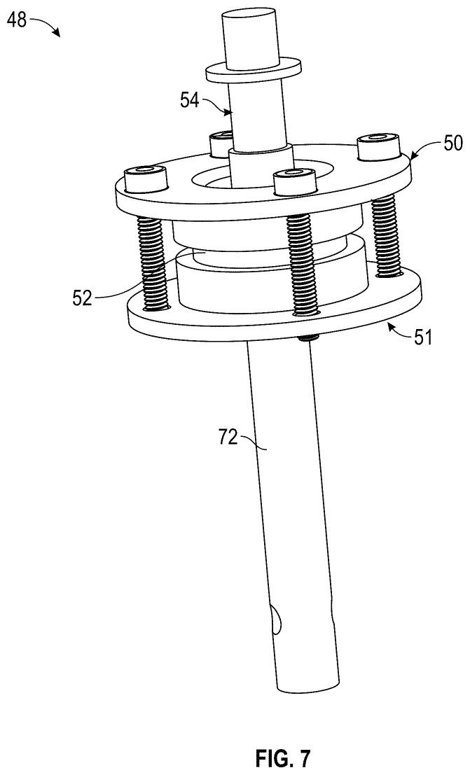

As shown, and with additional reference to FIG. 7, the leveling platform apparatus 40 of the active leveling platform assembly 36 can include an upper frame assembly 44 pivotably coupled to a lower frame assembly 46 at a pivotable joint 48. In the illustrated embodiment, the pivotable joint 48 can be a ball joint in which an upper collar 50 and a lower collar 51 are configured and arranged to at least partially receive a spheroid member such as a ball 52 therein having a shaft 54 extending upwardly therefrom such that the ball 52 is at least partially rotatably received within a seat formed between the collars 50, 51. The shaft 54 extends at least partially through or is otherwise coupled to the upper frame assembly 44 so as to pivotably coupled the upper frame assembly 44 and the lower frame assembly 46, e.g., so as to provide 3 rotational degrees of freedom (one about each of the X-axis, Y-axis, and Z-axis). In this regard, in some embodiments one or more bearings, lubricants, or other intermediary structures can be positioned between the ball and collar 50 of the pivotable joint 48 to facilitate pivotable movement therebetween.

In some embodiments, the upper frame assembly 44 of the leveling platform apparatus 40 can be symmetrically arranged about three parallel axes (axes parallel to the X-, Y-, and Z-axes) such that the ball 52 of the pivotable joint 48 can rotate to provide 3 rotational degrees of freedom.

It will be understood that other coupling structures could provide for relative movement between the upper frame assembly 44 and the lower frame assembly 46 without departing from the disclosure, for example, gimbals, rack-and-pinion arrangements, etc.

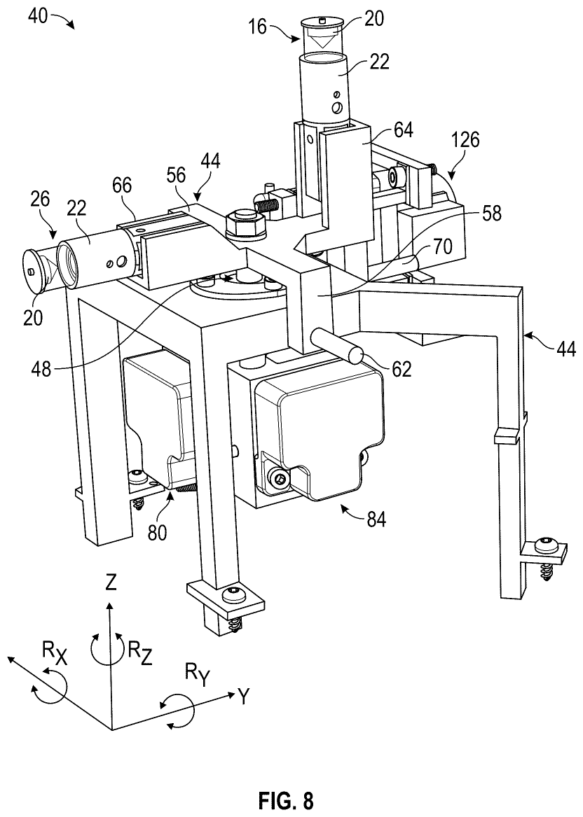

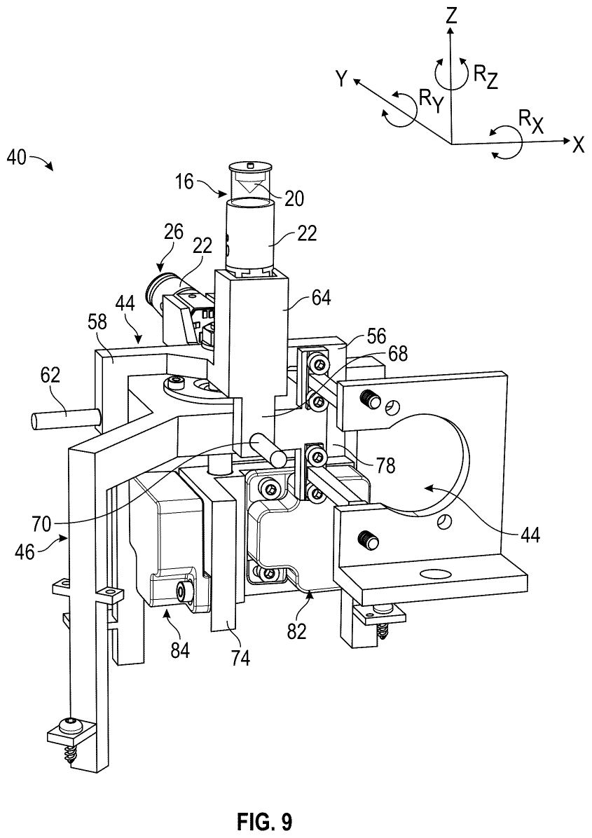

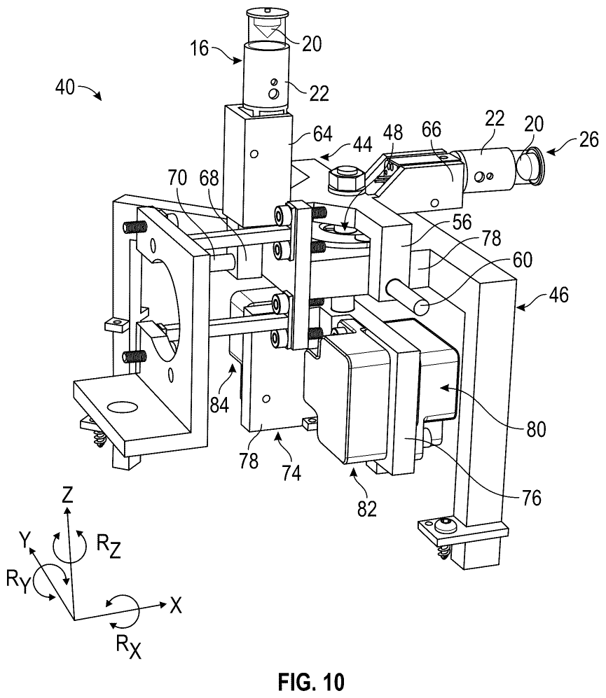

Referring additionally to FIGS. 8-10, the upper frame assembly 44, as shown, can be coupled to the shaft 54 of the pivotable joint 48 via a screw or other threaded member extending from the collar 50 through an aperture defined in the upper frame assembly 44 and secured thereto with a nut or other fastener. Accordingly, and as described further herein, upper frame assembly 44 can pivot relative to the lower frame assembly 46 via rotatable movement of the ball 52 of the joint 48 in the seat between the collars 50, 51 via the application of one or more forces to the shaft 54 extending therefrom.

The upper frame assembly 44 can at least partially define a respective first downwardly depending arm 56 and a second downwardly depending arm 58 opposite the arm 56. A respective compensation pin 60, 62 can be coupled to the respective arm 56, 58 extending outwardly therefrom such that forcible contact with a respective compensation pin 60, 62 can cause the upper frame assembly 44 and components supported thereon to pivot relative to the lower frame assembly 46/the surrounding housing 12 of the laser level apparatus 11 about the joint 48, as described further herein.

The upper frame assembly 44 can also at least partially define a third upwardly extending arm 64 at least partially defining a channel that at least partially receives the laser module 22 associated with the first laser projector 16. Similarly, a fourth arm 66 can be at least partially defined on the upper frame assembly 44 opposite the third arm 64 and can at least partially define a channel or shroud that at least partially receives the laser module 22 associated with the second laser projector 26.

A fifth arm 68 can depend downwardly from the third arm 64 so as to support a compensation pin 70 coupled thereto and extending outwardly therefrom such that forcible contact with the compensation pin 70 can also cause the upper frame assembly 44 and components supported thereon to pivot relative to the lower frame assembly 46 and the housing 12 of the laser level apparatus 11, as described further herein.

Compensation pins 60, 62, and 70 can be positioned such that their respective longitudinal axes, e.g., axes along which the pins 60, 62, 70 are elongate, pass through and intersect at the center of the ball 52 of the pivotable joint 48. This orientation prevents, for example, secondary motion in the X and/or Y directions due to forces acting on one or more of compensation pins 60, 62, or 70 about the Z-axis.

With continued reference to FIGS. 1-10, the lower frame assembly 46 can include a shaft 72 that is coupled to the ball within the joint 48, and which is at least partially received in a support block 74 that can include a first wall 76 and a second wall 78 extending away from the first wall 76. In some embodiments, the first wall 76 and the second wall 78 can be generally perpendicularly arranged, though a different configuration could be provided without departing from the disclosure.

The first wall 76 of the lower frame assembly 46 can support a first sensor assembly 80 and a second sensor assembly 82 (broadly, “second sensor assembly) on respective portions thereon. The second wall 78 can support a third sensor assembly 84 (broadly, “third sensor assembly”) thereon.

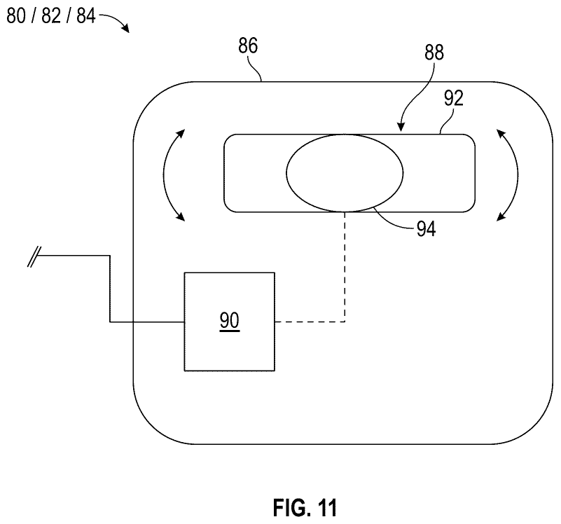

With momentary reference to FIG. 11, each sensor assembly 80, 82, 84 can optionally include an outer housing 86, a bubble vial 88, and an associated sensor 90. The bubble vial sensor 88 of the respective sensor assembly 80, 82, 84 can include a fluid filled vial 92 at least partially rotatably supported on the respective wall 76, 78 or an intermediary structure (such as a respective housing of the respective sensor assembly 80, 82, 84). The fluid filled vials 92 each include a bubble 94 of air or other gaseous pocket that is free to travel along the fluid within the respective vial 92.

As described further herein, when a respective bubble vial 92 is titled, the sensor 90 can respond to a position of the bubble 94 or a relative change in position of the bubble 94 to produce an electronic signal along associated circuitry indicative of an amount of tilt of the vial 92 and a corresponding level of tilt of the active leveling platform assembly 36. It will be understood that one or more of the sensors 90 can be optical, capacitive, impedance, or resistance sensors for producing an electronic signal in response to a position and/or change in position of the bubble 94 along a respective vial 92. It will be understood that one or more of the sensor assemblies 80, 82, 84 can be provided with a different sensor configuration without departing from the disclosure.

In some embodiments, a greater number of sensor assemblies can be employed (i.e., in addition to sensor assemblies 80, 82, 84). The additional sensor assemblies may be mounted in different locations and/or orientations on the lower frame assembly 46 based on the intended use and positioning of the laser leveling apparatus 11. For example, when the laser level assembly 10 is in the side laying orientation, a fourth sensor can be substituted as an alternative in situations where a particular bubble of a bubble vial sensor 88 (e.g., an optical sensor of sensor assembly 84) may not supply an accurate signal due to the orientation of a sensor assembly the laser level assembly 10, e.g., due to buoyancy and/or mechanical interference influencing the position of the bubble 94. In this example, a signal from the fourth sensor could be supplied to one of the aforementioned motor assemblies.

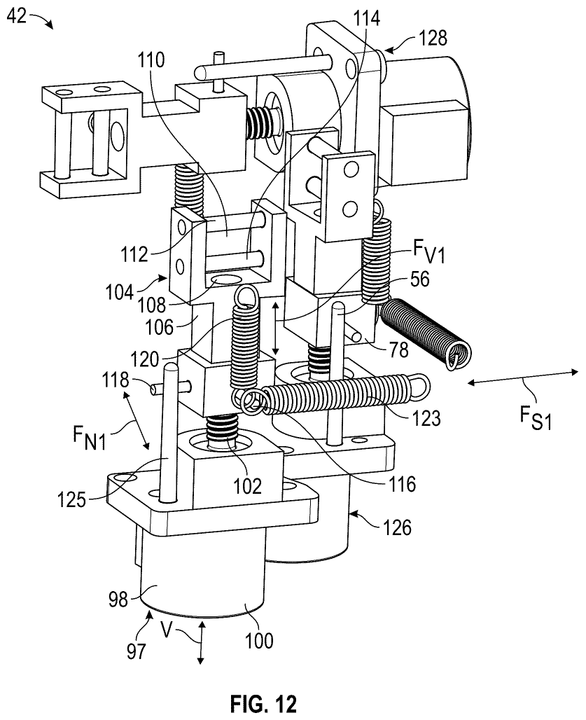

With additional reference to FIGS. 12-14, the compensation apparatus 42 of the active leveling platform assembly 36 can include a plurality of motor assemblies in mechanical cooperation with the leveling platform apparatus 40. In the illustrated embodiment, the motor assemblies can be mounted on the base 38 of the active leveling platform assembly 36.

As shown, a first motor assembly 97 of the compensation apparatus 42 can include a motor 98 that can have a motor housing 100 that supports one or more actuation members for rotating a lead screw 102 protruding from the motor housing 100. In the illustrated embodiment, the lead screw 102 can be a generally elongate member with a threaded outer surface for threadably engaging other components of the motor assembly 97.

In this regard, the motor 98 can receive electric power and operate to turn the lead screw 102 in a clockwise or counterclockwise direction. In some embodiments, the motor 98 can be a step motor or stepper motor, though the motor 98 could be a different type of motor, for example, another type of DC-powered brushless motor, without departing from the disclosure.

The lead screw 102 can be threadably received in a nut assembly 104 with a nut body 106 having a bore 108 at least partially defined therethrough with an at least partially threaded surface for threadably engaging the lead screw 102.

An upper portion of the nut body 106 can have a forked or bracketed configuration so as to at least partially define a gap 110 within which an upper engagement pin 112 and a lower engagement pin 114 are supported via attachment to respective portions of the nut body 106 so as to extend through the gap 110. In the illustrated embodiment, the upper engagement pin 112 and the lower engagement pin 114 are positioned in generally spaced and parallel arrangement so as to be arranged for at least partially receiving the compensation pin 62 of the leveling platform apparatus 40, as described further herein.

A lower portion of the nut body 106 can receive a first spring attachment pin 116 and a first anti-rotation pin 118 extending outwardly therefrom, each for inhibiting, minimizing, and/or preventing rotation of the nut body 106, as described further herein. The spring attachment pin 116 and the anti-rotation pin 118 can be supported on the nut body 106 at locations so as to extend in generally perpendicular relation to one another.

As shown, a vertical spring 120 and a generally horizontal springs 123 can each be coupled to the spring attachment pin 116. The vertical spring 120 can be a coil spring or a spring of another type with one end attached the compensation pin 62, and with an opposite end engaging the spring attachment pin 116. In some embodiments, at least one end of the vertical spring 120 can have a generally ring-like configuration so as to at least partially receive the pin 116 therethrough.

Similarly, the horizontal spring 123 can be a coil spring or a spring of another type with an end coupled to the housing 12, the lower frame assembly 46, or an associated support, and an opposite ring-like end at least partially receiving the pin 116 therethrough. In some embodiments, the vertical spring 120 and the horizontal spring 123 can have similar configurations, and in other embodiments, one of the springs 120, 123 can have a different property than the other, e.g., length, spring constant, etc.

The vertical spring 120 and the horizontal spring 123 can thus be arranged in generally perpendicular relation to one another. As described further herein, the springs 120, 123 can exert a biasing force on the anti-rotation pin 118 at rest and/or in tension so as to generally maintain a rotational position of the nut body 106 to which the anti-rotation pin 118 is attached to minimize, inhibit, and/or prevent unwanted rotation of the nut body 106 relative to the lead screw 102.

The anti-rotation pin 118, as shown, can be positioned such that the biasing force of spring 123 keeps maintains a preload between the pin 118 and anti-rotation post 125 at least partially received in the motor housing 100 and extending upwardly therefrom. Accordingly, and as described further herein, the anti-rotation pin 118 engages the anti-rotation post 125 so as to prevent unwanted rotation of the nut body 106 relative to the lead screw 102.

The first motor assembly 97 of the compensation apparatus 42, as shown, can be mounted to the base 38 of the active leveling platform assembly 36 and can be associated with the first sensor assembly 80, as described further herein. As shown, the first motor assembly 97 can be positioned at a location such that the compensation pin 62 extending from the upper frame assembly 44 extends at least partially into the gap 110 between the upper engagement pin 112 and the lower engagement pin 114.

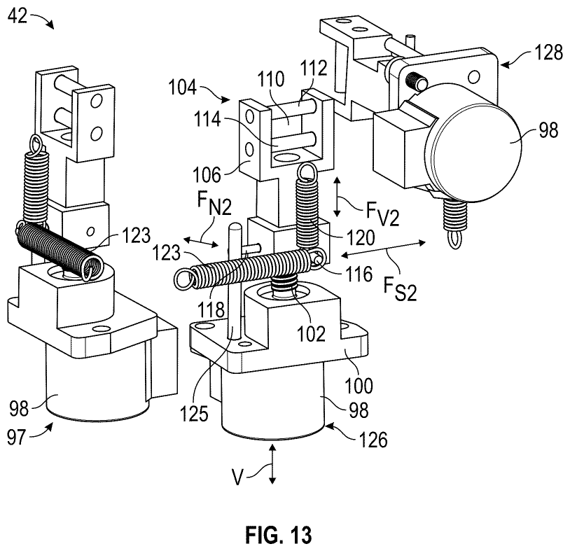

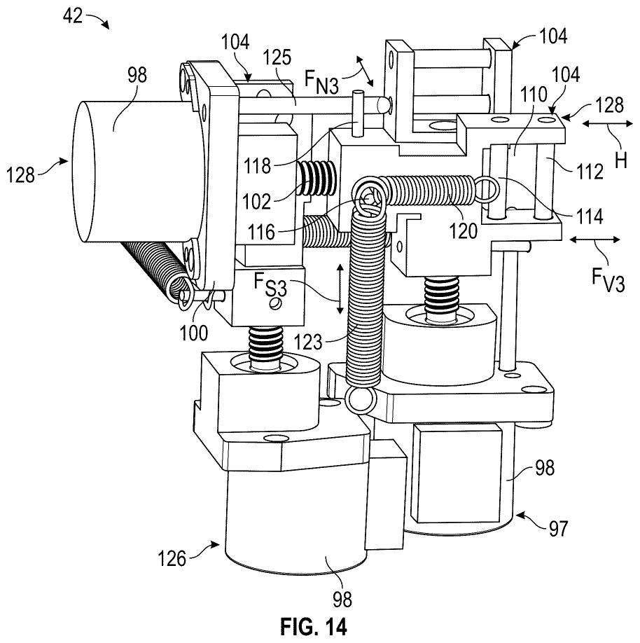

With continued reference to FIGS. 13-14, a second motor assembly 126 can include a motor 98, lead screw 102, nut assembly 104, engagement pins 112, 114, spring attachment pin 116, anti-rotation pin 118, springs 120 and 123 and associated features with a construction and arrangement similar to that described above with respect to the first motor assembly 97, except that one end of the vertical spring 120 is attached to the compensation pin 70.

As shown, the second motor assembly 126 can be mounted to the base 38 of the active leveling platform assembly 36 and can be associated with the sensor assembly 84, as described further herein. The second motor assembly 126 can be positioned at a location such that the compensation pin 70 extending from the upper frame assembly 44 extends at least partially between the upper engagement pin 112 and the lower engagement pin 114 of the second motor assembly 126.

Each of the first motor assembly 97 and the second motor assembly 126 can thus be mounted to the base 38 of the active leveling platform assembly 36 so to the respective lead screws 102 extend generally upwardly parallel to the Z-axis, and, as described further herein, can be configured to at least partially move, e.g., via the respective nut bodies 106, along a vertical direction parallel to the Z-axis.

A third motor assembly 128 can be mounted to the housing 12 of the laser level apparatus 11 so as to extend generally parallel to the X-axis, as shown. The third motor assembly 128, similar to the motor assemblies 97, 126 described above, can include a motor 98, lead screw 102, nut assembly 104, engagement pins 112, 114, spring attachment pin 116, anti-rotation pin 118, springs 120, and 123, and associated features.

However, the motor 98 of the third motor assembly 128 can be mounted directly to the housing 12 of the laser level apparatus 11 or an intermediate structure so as to be free from connection to the base 38 of the laser level apparatus 11, as described further herein. The third motor assembly 38 can be associated with the sensor assembly 82, though the third motor assembly 38 and associated sensor assembly 82 may not be used when the laser level apparatus 10 is in the upright orientation.

In the illustrated embodiment, the motor assembly 128 can be mounted to the housing 12 and oriented in a manner such that the compensation pin 60 extending from the upper frame assembly 44 extends at least partially into the gap 110 between the upper engagement pin 112 and the lower engagement pin 114 of the motor assembly 128. Furthermore, the spring 120 can be oriented horizontally, e.g., along an axis parallel to the X-axis, and the spring 123 can be oriented vertically, e.g., along axes parallel to the Z-axis, and can have an end attached to the compensation pin 60.

In view thereof, the first motor assembly 97 can be positioned such that the motor 98 thereof can threadably drive the respective nut assembly 104 via the lead screw 102 in forward and reverse directions parallel to the Z-axis, e.g., along a vertical direction V such that one or both of the engagement pins 112, 114 can contact the compensation pin 62 and urge the upper frame assembly 44 to at least partially tilt/rotate about an axis parallel to the X-axis in response to one or more signals received from the sensor assembly 80.

Similarly, the second motor assembly 126 can be positioned such that the motor 98 thereof can threadably drive the respective nut assembly 104 via the lead screw 102 in forward and reverse directions parallel to the Z-axis, e.g., along the vertical direction V, such that one or both of the respective engagement pins 112, 114 can contact the compensation pin 70 and urge the upper frame assembly 44 to at least partially tilt/rotate about an axis parallel to the Y-axis in response to one or more signals received from the sensor assembly 84.

Further still, the third motor assembly 128 can be positioned such that the motor 98 thereof can threadably drive the respective nut assembly 104 via the lead screw 102 in forward and reverse directions parallel to the X-axis, e.g., along a horizontal direction H, such that one or both of the respective engagement pins 112, 114 can contact the compensation pin 60 and urge the upper frame assembly 44 to at least partially tilt/rotate about an axis parallel to the Z-axis in response to one or more signals received from the sensor assembly 82.

Accordingly, the motor assemblies 97, 126, 128 are operably coupled to the upper frame assembly 44 of the active leveling platform assembly 36 to at least partially rotate the upper frame assembly 44 about each of the X-axis, Y-axis, and Z-axis via the ball joint 48 seated within the collars 51, 52.

In this regard, when the laser level assembly 10 is in the upright orientation, the upper frame assembly 44 can pivot about the X-axis as indicated by the bi-directional arrow R_{X} via action of the motor assembly 97 in coordination with the sensor assembly 80, e.g., to affect pitch, the upper frame assembly 44 can pivot about the Y-axis as indicated by the bi-directional arrow R_{Y} via action of the motor assembly 126 in coordination with the sensor assembly 84, e.g., to affect roll. Though the associated action of the motor assembly 128 and the sensor assembly 82 may not be used when the laser level assembly 10 is in the upright orientation, the upper frame assembly 44 is capable of pivoting about the Z-axis as indicated by the bi-directional arrow R_{Z} via action of the motor assembly 128 in coordination with the sensor assembly 82, e.g., to affect yaw.

When the laser level assembly 10 is in the side lying orientation, the upper frame assembly 44 can pivot about the X-axis as indicated by the bi-directional arrow R_{X} via action of the motor assembly 97 in coordination with the sensor assembly 82, and the upper frame assembly 44 can pivot about the Z-axis as indicated by the bi-directional arrow R_{Z} via action of the motor assembly 128 in coordination with the sensor assembly 84. Though the associated action of the motor assembly 126 and the sensor assembly 80 may not be used when the laser level assembly 10 is in the side lying orientation, the upper frame assembly 44 is capable of pivoting about the Y-axis as indicated by the bi-directional arrow R_{Y} via action of the motor assembly 126 in coordination with the sensor assembly 80.

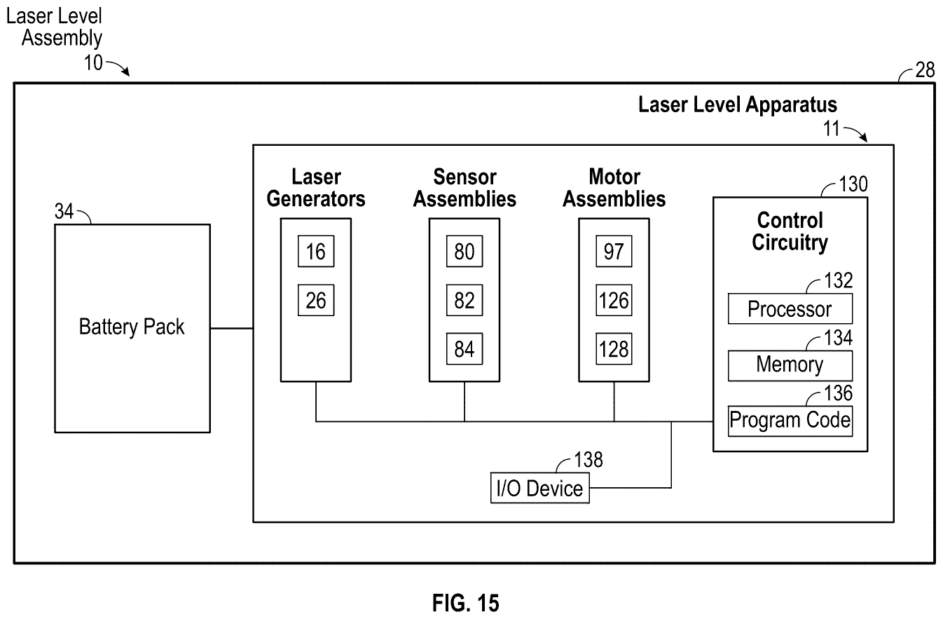

Referring additionally to FIG. 15, a schematic diagram associated with the laser level assembly 10 is illustrated according to an exemplary embodiment of the disclosure.

As shown, the battery pack 34 and the laser level apparatus 11 can be at least partially supported on the base 28 of the laser level assembly 10 and can be in electrical communication with one another, e.g., such that electrical power from the battery pack 34 can be supplied to the laser level apparatus 11 along one or more wires, terminals, contacts, etc., therebetween.

In this regard, the battery pack 34 can supply electrical power to the laser projectors 16, 26 of the laser level apparatus, and the sensors 90 and/or motors 98 of the active leveling platform assembly 36 of the laser level apparatus 11. It will be understood that additional or alternative configurations of power supplying devices can be provided to supply electrical power to such components without departing from the disclosure. In some embodiments, the battery pack 34 can be provided with a predetermined voltage potential, such as 3.67V, 3.3V, 14V, 8V, etc. In some embodiments, the laser level apparatus 11 may be configured to receive battery packs of different sizes or voltages. For example, in an example embodiment, the laser level apparatus 11 may be configured to receive a battery pack with a maximum initial voltage of approximately 12 volts (V) (measured without a workload) or a battery pack with a maximum initial voltage of approximately 20 V (measured without a workload), so that the laser level apparatus 11 can operate with batteries of different voltage potentials.

The battery pack 34 can also supply power to control circuitry 130 associated with the active leveling platform assembly 36 and/or the laser projectors 16, 26 to effect various functions and processes thereof, as described further herein. In particular, the control circuitry 130 can be configured to receive signals from the sensors 90 of the sensor assemblies 80, 82, 84 and produce motor driving signals to the various motors 98 to move and actively level the active leveling platform assembly 36. In this regard, the control circuitry 130 can include one or more associated motor drivers.

In this regard, the control circuitry 130 according to some example embodiments of the present disclosure. The control circuitry 130 may can include one or more of each of a number of components such as, for example, a processor 132 connected to a memory 134. The processor is generally any piece of computer hardware capable of processing information such as, for example, data, computer programs and/or other suitable electronic information. The processor includes one or more electronic circuits some of which may be packaged as an integrated circuit or multiple interconnected integrated circuits (an integrated circuit at times more commonly referred to as a “chip”). The processor 132 may be a number of processors, a multi-core processor or some other type of processor, depending on the particular embodiment.

The processor(s) 132 may be configured to execute computer programs such as computer-readable program code 136, which may be stored onboard the processor(s) 132 or otherwise stored in the memory 134. In some examples, the processor may be embodied as or otherwise include one or more ASICs, FPGAs or the like. Thus, although the processor(s) 132 may be capable of executing a computer program to perform one or more functions, the processor of various examples may be capable of performing one or more functions without the aid of a computer program.

The memory 134 can be generally any piece of computer hardware capable of storing information such as, for example, data, computer-readable program code 136 or other computer programs, and/or other suitable information either on a temporary basis and/or a permanent basis. The memory may include volatile memory such as random access memory (RAM), and/or non-volatile memory such as a hard drive, flash memory or the like. In various instances, the memory may be referred to as a computer-readable storage medium, which is a non-transitory device capable of storing information. In some examples, then, the computer-readable storage medium is non-transitory and has computer-readable program code stored therein that, in response to execution by the processor 132, causes the control circuitry 130 to perform various operations as described herein, some of which may in turn cause the laser level assembly 10 to perform various operations.

In addition to the memory 134, the processor 132 may also be connected to one or more input/output (I/O) devices 138 or the like. The I/O device 138 may include one or more input devices capable of receiving data or instructions for the control circuitry 130, and/or one or more output devices capable of providing an output from the control circuitry 130. Examples of suitable input devices include a remote control, button(s) on the housing 12 or base 28, keyboard, keypad or the like, and examples of suitable output devices include a display device such as a one or more light-emitting diodes (LEDs), a LED display, a liquid crystal display (LCD), or the like.

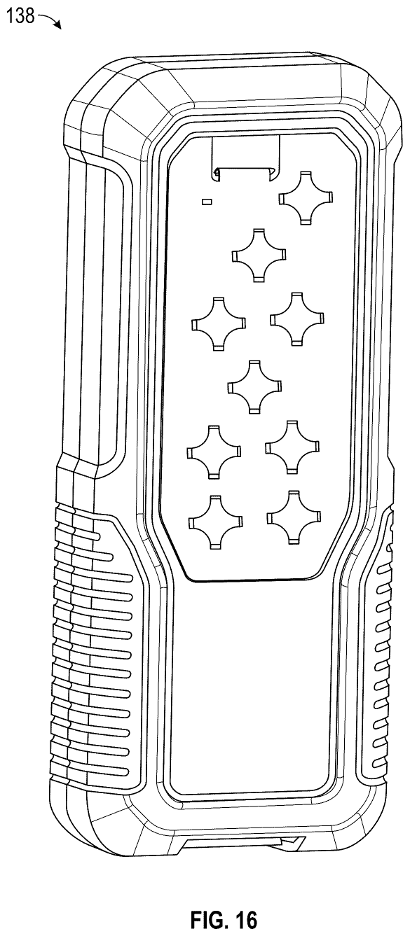

In some embodiments, the I/O device 138 can be a handheld device, for example a handheld remote or a customized app on a mobile phone. With momentary reference to FIG. 16, an example handheld device that can be used as an I/O device 138 is illustrated, and could provide one or more signals to the laser level assembly 10 through a wired or wireless communication protocol, for example, Bluetooth wireless signal, near field communication (NFC), infrared beam, etc. Such a handheld device could provide a variety of instructions to the laser leveling assembly 10, for example, an instruction to activate one or both of the laser generators 16, 26 to generate the respective laser line 17, 27, can provide user-controlled activation of one or more of the motor assemblies 97, 126, 128 to tilt the upper frame assembly 44 of the active leveling platform assembly 36 a desired amount and/or direction, can reset or cancel one or more alerts or fault states, etc.

In some embodiments, the control circuitry 130 may be included within some or all of the following components discussed above, e.g., the laser projectors 16, 26, the sensor assemblies 80, 82, 84, the motor assemblies 97, 126, 128, etc., in distributed or networked fashion. The control circuitry 130 can include one or more pathways of electrical communication between such components, or could be in electrical communication with such pathways. In some embodiments, the control circuitry 130 can be associated with the battery pack 34, e.g., to control charging, discharging, and/or monitoring operations thereof. Other configurations for the control circuitry and associated communication among components of the laser level assembly 10 are contemplated within the scope of the present disclosure.

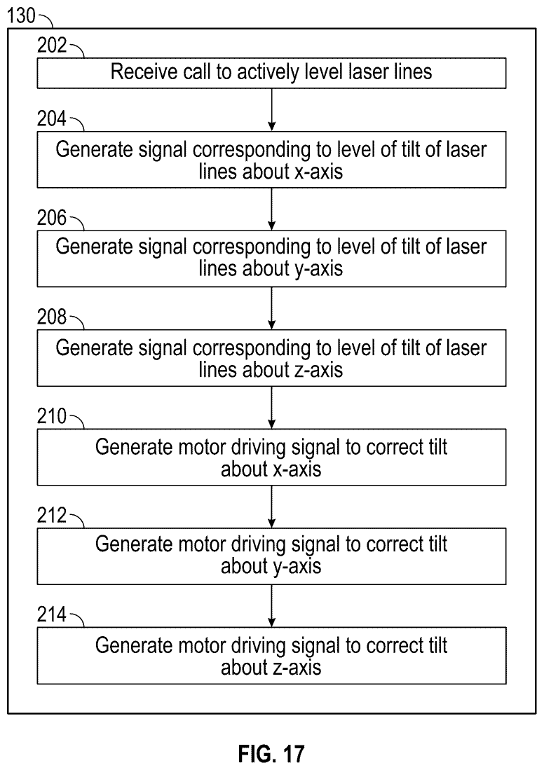

FIG. 17 shows a block diagram of how the disclosed laser level assembly 10 may operate to provide one or more active leveling operations, which in some embodiments includes some or all of the features discussed above. Each of these steps will be discussed in more detail below, however, an overview is first provided with reference to the preceding FIGS. 1-16.

At step 202 of the depicted embodiment, the control circuitry 130 receives an instruction to actively level the laser lines 17, 19 projected by the laser projectors 16, 26. Such an instruction can, in some embodiments, be generated directly by the control circuitry 130 itself, e.g., as part of a continuous monitoring protocol, timer, positional sensor configured to receive signals associated with one or more reorientations of the laser level assembly 10, etc. In some embodiments, such an instruction can be provided by the I/O device 138, for example, a physically pressable or touchscreen button input to actively level the laser lines 17, 19.

At step 204, the sensor assembly 80 can produce an electronic signal indicative of a level of tilt of the laser projectors 16, 26 and the associated respective laser lines 17, 19 produced thereby relative to the X-axis.

In order to produce such a signal, the sensor assembly 80 can receive a signal associated with the relative position of the bubble 88 in the fluid filled vial 92. In some embodiments, the sensor 90 can produce, via the control circuitry 130, an electronic signal corresponding to a voltage that is about zero or within a predetermined threshold if the bubble 88 is centered within the vial 92 along a direction parallel to the X-axis.

If the bubble 88 is offset from such a centered position, the sensor 90 can produce a corresponding value, which in some embodiments can be a nonzero value or a value outside of a predetermined threshold.

It will be understood that the foregoing signal generation with respect to the X-axis may be associated with the laser level assembly 10 in the upright orientation, and that such signal may be received from the sensor assembly 82 when the laser level assembly 10 is in the side lying orientation.

At a step 206, the sensor assembly 84 can produce an electronic signal indicative of a level of tilt of the laser projectors 16, 26 and the associated respective laser lines 17, 19 produced thereby relative to the Y-axis.

Producing such a signal can include the sensor assembly 84 receiving a signal associated with the relative position of the bubble 88 in the fluid filled vial 92 thereof. In some embodiments, the sensor 90 can produce, via the control circuitry 130, an electronic signal corresponding to a voltage that is about zero or a value within a predetermined threshold if the bubble 88 is centered within the vial 92 along a direction parallel to the Y-axis.

If the bubble 88 is offset from such a centered position along the Y-axis, the sensor 90 can produce an electronic signal that is greater than or less than about zero or outside of a predetermined threshold.

It will be understood that the foregoing signal generation with respect to the Y-axis may be associated with the laser level assembly 10 in the upright orientation, and may not be implemented when the laser level assembly 10 is in the side lying orientation.

At a step 208, if the laser level assembly 10 is in the side laying orientation, the sensor assembly 84 can produce an electronic signal indicative of a level of tilt of the laser projectors 16, 26 and the associated respective laser lines 17, 19 produced thereby relative to the Z-axis.

Producing such a signal can include the sensor assembly 84 receiving a signal associated with the relative position of the bubble 88 in the fluid filled vial 92 thereof. In some embodiments, the sensor 90 can produce, via the control circuitry 130, an electronic signal corresponding to a voltage that is about zero or a value within a predetermined threshold if the bubble 88 is centered within the vial 92 along a direction parallel to the Z-axis.

If the bubble 88 is offset from such a centered position along the Z-axis, the sensor 90 can produce an electronic signal that is greater than or less than about zero (e.g., zero or within a predetermined threshold thereof).

It will be understood that the foregoing signal generation with respect to the Z-axis may not be implemented when the laser level assembly 10 is in the side lying orientation.

It will be understood that the foregoing steps 202, 204, 206 can occur simultaneously or in sequence, and that the sequence of action of the sensor assemblies 80, 82, 84 can occur in a different order without departing from the disclosure. For example, when the laser level assembly 10 is in the upright orientation, the step 204 could occur before step 202 for tilt about the X-axis and Y-axis. Similarly, when the laser level assembly 10 is in the side laying orientation, the step 206 could occur before step 202 for tilt about the X-axis and Z-axis.

At a step 210, the control circuitry 130 can generate an electronic motor driving signal associated with an amount of corrective tilt needed to counteract the amount of tilt indicated by the sensor assembly 80. In this regard, the control circuitry 130 can be configured to transmit the electronic motor driving signal to the motor assembly 97 to cause the motor 100 thereof to rotate the drive screw 102 either clockwise or counterclockwise, e.g., in the vertical direction V (FIG. 12) to cause the nut assembly 104 threadably engaged therewith to travel vertically upward or downward along the lead screw 102.

In this regard, the nut assembly 104 can travel upwardly or downwardly along the V direction such that a respective engagement pin 112, 114 can contact the compensation pin 62 and urge the downwardly depending arm 58 upwardly or downwardly, as the case may be, so as to cause the upper frame assembly 44 to pivot the ball 52 of the joint 48 about the X-axis, as indicated by the bi-directional arrow R_{X}.

As described herein, an amount of upward or downward movement of the compensation pin 62 caused by engagement with the respective engagement pin 112, 114 can cause a desired amount of tilt of the upper frame assembly 44 about the X-axis. Such tilt can thus be determined by the control circuitry 130, and a corrective amount of movement about the X-axis to counteract an amount of tilt signaled by the sensor assembly 80 can be achieved.

Accordingly, the laser projectors 16, 26 supported on the upper frame assembly 44 can be rotated in kind about the X-axis such that the respective laser lines 17, 27 projected therefrom can be adjusted toward a level position with respect to the X-axis, e.g., so as to be aligned therewith.

It will be understood that anti-rotation features of the laser leveling apparatus 11 can maintain a relative rotational arrangement of the nut body 106 about the lead screw 102, e.g., so as to minimize, inhibit, and/or prevent misalignment of the motor assembly 97 in the course of operation thereof.

For example, to the extent the nut body 106 of the motor assembly 97 begins to rotate relative to the lead screw 102, the spring 123 can exert force F_{S1} along an axis parallel to the X-axis on the spring attachment pin 116 that is perpendicular or normal to a force F_{N1} exerted by the anti-rotation pin 118 on the respective anti-rotation post 125.

Such intersecting forces F_{S1} and F_{N1} can provide a generally bracing arrangement that resists rotation of the nut body 106 in either clockwise or counter-clockwise directions about the lead screw 102 of the motor assembly 97, e.g., so as to stabilize the rotational position thereof and avoid misalignment of the motor assembly 97 during use.

Furthermore, the spring 120, attached to spring attachment pin 116 and compensation pin 62, can exert a vertical force F_{V1} that may tend to bias contact of the compensation pin 62 with the lower engagement pin 114, e.g., so as to avoid travel of the compensation pin 62 along the gap 110, e.g., backlash.

It will be understood that the foregoing correction may be associated with the laser level assembly 10 in the upright orientation, and that a motor driving signal for the motor assembly 97 can be at least partially generated based on one or more signals from the sensor assembly 82 to effect correction about the X-axis.

At a step 212, the control circuitry 130 can generate an electronic motor driving signal associated with an amount of corrective tilt needed to counteract the amount of tilt indicated by the sensor assembly 84 about the Y-axis. In this regard, the control circuitry 130 can be configured to transmit the electronic motor driving signal to the motor assembly 126 to cause the motor 100 thereof to rotate the drive screw 102 either clockwise or counterclockwise (about an axis parallel to the Z-axis) to cause the nut assembly 104 threadably engaged therewith to travel vertically upward or downward along the lead screw 102.

The nut assembly 104 associated with the motor assembly 126 can thus travel upwardly or downwardly along the V direction such that a respective engagement pin 112, 114 can contact the compensation pin 70 and urge the downwardly depending arm 68 upwardly or downwardly so as to cause the upper frame assembly 44 to pivot the ball 52 of the joint 48 about the Y-axis, as indicated by the bi-directional arrow R_{Y}.

As described herein, an amount of upward or downward movement of the compensation pin 70 caused by engagement with the respective engagement pin 112, 114 can cause a desired amount of tilt of the upper frame assembly 44 about the Y-axis. Such tilt can thus be determined by the control circuitry 130, and a corrective amount of movement about the Y-axis to counteract an amount of tilt signaled by the sensor assembly 84 can be achieved.

Accordingly, the laser projectors 16, 26 supported on the upper frame assembly 44 can be rotated in kind about the Y-axis such that the respective laser lines 17, 27 projected therefrom can be adjusted toward a level position with respect to the Y-axis, e.g., so as to be aligned therewith.

As described above with respect to the motor assembly 97, anti-rotation features of the laser leveling apparatus 11 can maintain a relative rotational arrangement of the nut body 106 about the lead screw 102, e.g., so as to minimize, inhibit, and/or prevent misalignment of the motor assembly 126 in the course of operation thereof.

To the extent the nut body 106 of the motor assembly 126 begins to rotate relative to the lead screw 102, the spring 123 can exert force F_{S2} along an axis parallel to the Y-axis on the spring attachment pin 116 that is perpendicular or normal to a force F_{N2} exerted by the anti-rotation pin 118 on the respective anti-rotation post 125.

Such intersecting forces F_{S2} and F_{N2} can provide a generally bracing arrangement that resists rotation of the nut body 106 in either clockwise or counter-clockwise directions about the lead screw 102 of the motor assembly 126, e.g., so as to stabilize the rotational position thereof and avoid misalignment of the motor assembly 126 during use.

Furthermore, the spring 120, attached to spring attachment pin 116 and compensation pin 70, can exert a vertical force F_{V2} that may tend to bias contact of the compensation pin 70 with the lower engagement pin 114, e.g., so as to avoid travel of the compensation pin 70 along the gap 110, e.g., backlash.

It will be understood that the foregoing correction about the Y-axis may be associated with the laser level assembly 10 in the upright orientation, and may not be utilized when the laser level assembly 10 is in the side-lying orientation.

Further, at a step 216, if the laser leveling apparatus 11 is in the side laying orientation, the control circuitry 130 can generate an electronic motor driving signal associated with an amount of corrective tilt needed to counteract the amount of tilt indicated by the sensor assembly 84 about the Z-axis. In this regard, the control circuitry 130 can be configured to transmit the electronic motor driving signal to the motor assembly 128 to cause the motor 100 thereof to rotate the drive screw 102 either clockwise or counterclockwise (about an axis parallel to the X-axis) to cause the nut assembly 104 threadably engaged therewith to travel horizontally along the lead screw 102 in the horizontal direction H.

The nut assembly 104 associated with the motor assembly 128 can thus travel horizontally along a direction parallel to the X-axis such that a respective engagement pin 112, 114 can contact the compensation pin 60 and urge the downwardly depending arm 56 left or right so as to cause the upper frame assembly 44 to pivot the ball 52 of the ball joint 48 about the Z-axis, as indicated by the bi-directional arrow R_{Z}.

As described herein, an amount of horizontal movement of the compensation pin 60 caused by engagement with the respective engagement pin 112, 114 can cause a desired amount of tilt of the upper frame assembly 44 about the Z-axis. Such tilt can thus be determined by the control circuitry 130, and a corrective amount of movement about the Y-axis to counteract an amount of tilt signaled by the sensor assembly 84 can be achieved.

Accordingly, the laser projectors 16, 26 supported on the upper frame assembly 44 can be rotated in kind about the Z-axis such that the respective laser lines 17, 27 projected therefrom can be adjusted toward a level position with respect to the Z-axis, e.g., so as to be aligned therewith.

As described above with respect to the motor assemblies 97, 126, anti-rotation features of the laser leveling apparatus 11 can maintain a relative rotational arrangement of the nut body 106 about the lead screw 102, e.g., so as to minimize, inhibit, and/or prevent misalignment of the motor assembly 128 in the course of operation thereof.

To the extent the nut body 106 of the motor assembly 128 begins to rotate relative to the lead screw 102, the spring 123 can exert force F_{S3} along an axis parallel to the Y-axis on the spring attachment pin 116 that are perpendicular or normal to a force F_{N3} exerted by the anti-rotation pin 118 on the respective anti-rotation post 125.

Such intersecting forces F_{S3} and F_{N3} can provide a generally bracing arrangement that resists rotation of the nut body 106 in either clockwise or counter-clockwise directions about the lead screw 102 of the motor assembly 128, e.g., so as to stabilize the rotational position thereof and avoid misalignment of the motor assembly 128 during use.

Furthermore, the spring 120, attached to spring attachment pin 116 and compensation pin 60 can exert a force F_{V3} on the anti-rotation pin 116 that tends to maintain contact of the compensation pin 60 with engagement pin 114, e.g., so as to avoid travel of the compensation pin 60 along the gap 110, e.g., backlash.

As described further herein, control of one or more of the motor assemblies 97, 126, 128 effected by the control circuitry 130 can be implemented according to one or more methods to achieve a desired level of coarse or fine control. It will be further understood that the foregoing control of the one or more motor assemblies 97, 126, 128 can occur in multiple stages at least partially determined by continuous or intermittent feedback from one or more of the sensor assemblies 80, 82, 84.

It will be understood that the foregoing steps 210, 212, 214 can occur simultaneously or in sequence, for example, based on whether the laser level assembly 10 is in the upright or side lying orientation, and that the sequence of action of the motor assemblies 97, 126, 128 can occur in a different order without departing from the disclosure. For example, the step 212 could occur before either of the steps 210, 214, the step 214 could occur before either of the steps 210, 212, etc.

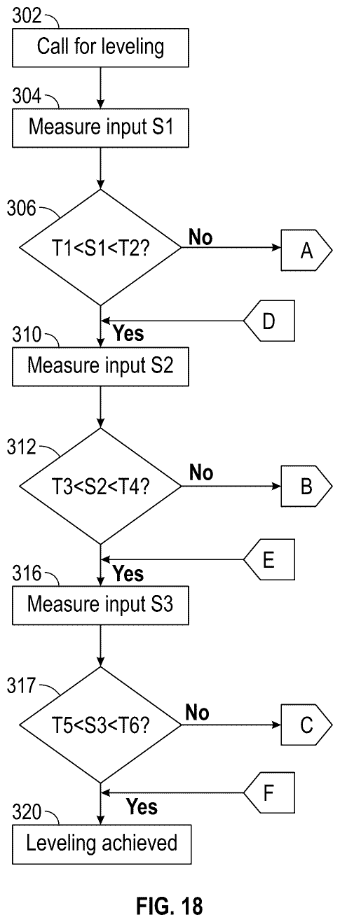

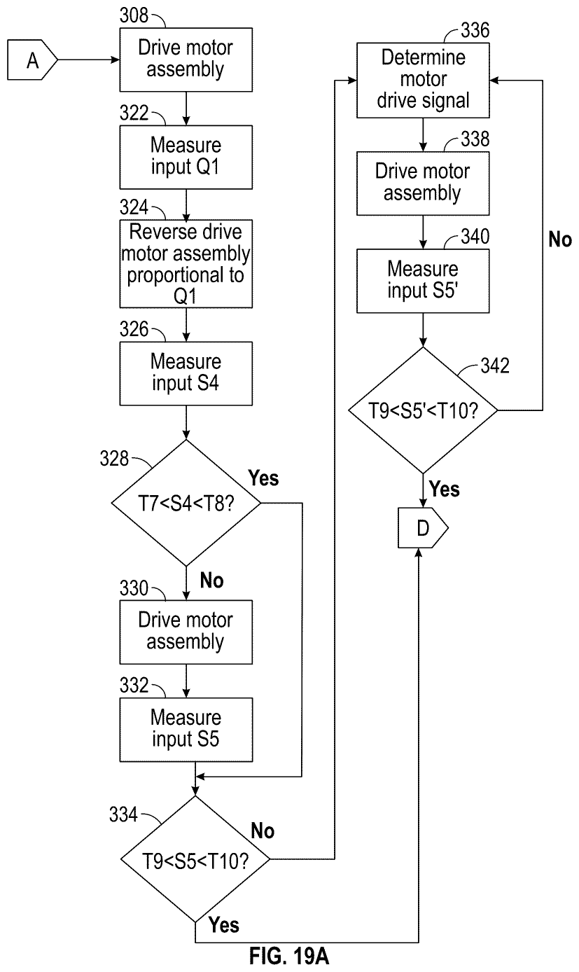

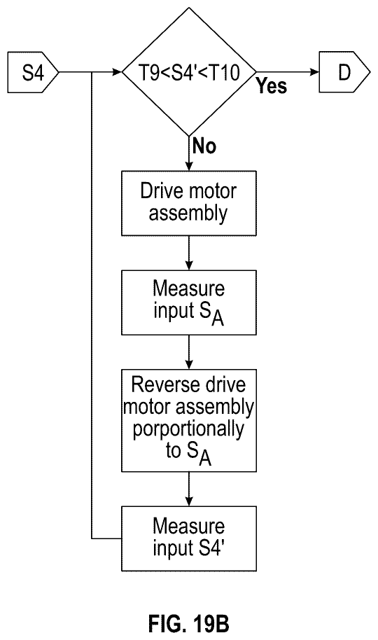

FIG. 18 shows a flowchart according to an example embodiment of the present disclosure for actively leveling the laser projectors 16, 26 of the laser level assembly 10. FIGS. 19A, 20A, and 21A continue the flowchart of FIG. 18.

In the illustrated embodiment, at step 302, the control circuitry 130 determines whether active leveling of the laser projectors 16, 26 has been called for. In some embodiments, a need or call for active leveling of the laser projectors 16, 26 can be generated directly by the control circuitry 130 itself, e.g., as part of a continuous monitoring protocol, timer, positional sensor configured to receive signals associated with one or more reorientations of the laser level assembly 10, etc. In some embodiments, such an instruction can be provided by the I/O device 138, for example, a physically pressable or touchscreen button input to actively level the laser lines 17, 19.

If active leveling of the laser projectors 16, 26 is called for, the control circuitry 130 can measure an input S1 at a step 304 from the sensor assembly 80 (or sensor assembly 82 if laser level assembly 10 is in the side laying orientation) corresponding to an amount of tilt about the X-axis. Such input S1 can be a voltage signal or other electronic signal generated by the sensor 90 of the sensor assembly 80/82 indicative of a relative position of the bubble 94 in the vial 92 thereof.

At a step 306, the control circuitry 130 can determine whether the input S1 is less than a threshold value T1 or greater than a threshold value T2 indicating a condition in which the one or both of the laser projectors 16, 26 and projected laser lines 17, 27 are not level about the X-axis. The threshold values T1 and T2 can be preselected values corresponding to positions of the bubble 94 in the vial 92 of the sensor assembly 80/82 that indicate a condition in which the bubble 94 is not centered in the vial 92 or within a preselected level of tolerance. In some embodiments, the threshold values T1 and T2 can be voltage values between and including about 0V and about 3.5V, including integer and non-integer values therebetween.

In some embodiments, an input S1 from the sensor assembly 80/82 at or less than the threshold value T1 can indicate a condition in which one or both of the laser lines 17, 27 are tilted below a level condition with respect to the X-axis, and an input S1 from the sensor assembly 80 at or greater than the threshold value T2 can indicate a condition in which the one or both of the laser lines 17, 27 are tilted above a level condition with respective to the X-axis.

In other embodiments, an input S1 from the sensor assembly 80/82 at or less than the threshold value T1 can indicate a condition in which one or both of the laser lines 17, 27 are tilted above a level condition with respect to the X-axis, and an input S1 from the sensor assembly 80/82 at or greater than the threshold value T2 can indicate a condition in which the one or both of the laser lines 17, 27 are tilted below a level condition with respective to the X-axis.

If the input S1 from the sensor assembly 80/82 is such that T1<S1<T2 is false or no, the process can proceed to a step 308, in which control of the motor assembly 97 is effected by the control circuitry 130, as described further herein.

However, if the input S1 from the sensor assembly 80 is such that T1<S1<T2 is true, and laser level assembly 10 is in the upright orientation, the process can proceed to a step 310, in which an input S2 from the sensor assembly 84 corresponding to an amount of tilt of the laser projectors 16, 26 and projected laser lines 17, 27 about the Y-axis is measured.

Such input S2 can be a voltage signal or other electronic signal generated by the sensor 90 of the sensor assembly 84 indicative of a relative position of the bubble 94 in the vial 92 thereof.

In a step 310, the control circuitry 130 can determine whether the input S2 is less than a threshold value T3 or greater than a threshold value T4 indicating a condition in which one or both of the laser projectors 16, 26 and projected laser lines 17, 27 are not level about the Y-axis when the laser level assembly 10 is in the upright orientation. The threshold values T3 and T4 can be preselected values corresponding to positions of the bubble 94 in the vial 92 of the sensor assembly 84 that indicate a condition in which the bubble 94 is not centered in the vial 92 or within a preselected level of tolerance. In some embodiments, the threshold values T3 and T4 can be voltage values between and including about 0V and about 3.5V, including integer and non-integer values therebetween.

In some embodiments, an input S2 from the sensor assembly 84 at or less than the threshold value T3 can indicate a condition in which one or both of the laser lines 17, 27 are tilted below a level condition with respect to the Y-axis, and an input S2 from the sensor assembly 84 at or greater than the threshold value T4 can indicate a condition in which one or both of the laser lines 17, 27 are tilted above a level condition with respective to the Y-axis.

In other embodiments, an input S2 from the sensor assembly 84 at or less than the threshold value T3 can indicate a condition in which one or both of the laser lines 17, 27 are tilted above a level condition with respect to the Y-axis, and an input S2 from the sensor assembly 84 at or greater than the threshold value T4 can indicate a condition in which one or both of the laser lines 17, 27 are tilted below a level condition with respective to the Y-axis.

If the input S2 from the sensor assembly 84 is such that T3<S2<T4 is false or no, the process can proceed to a step 314, in which control of the motor assembly 126 is effected by the control circuitry 130, as described further herein.

When the laser level assembly 10 is in the side laying orientation and sensor assembly 82 is used to measure the input S2 for a level condition with respect to the X-axis, if S2 is such that T3<S2<T4 is false or no, the process can proceed to a step 314, in which control of the motor assembly 126 is effected by the control circuitry 130, as described further herein.

In the side laying orientation, when input S2 is from sensor assembly 82 is such that T3<S2<T4 is true or yes, the process can proceed to a step 316, in which an input S3 from the sensor assembly 84 corresponding to an amount of tilt of the laser projectors 16, 26 and resultant laser lines 17, 27 about the Z-axis is measured.

Such input S3 can be a voltage signal or other electronic signal generated by the sensor 90 of the sensor assembly 84 indicative of a relative position of the bubble 94 in the vial 92 thereof.

In a step 317, the control circuitry 130 can determine whether the input S3 is less than a threshold value T5 or greater than a threshold value T6 indicating a condition in which one or both of the laser projectors 16, 26 are not level about the Z-axis when the laser level assembly 10 is in the side laying orientation. The threshold values T5 and T6 can be preselected values corresponding to positions of the bubble 94 in the vial 92 of the sensor assembly 84 that indicate a condition in which the bubble 94 is not centered in the vial 92 or within a preselected level of tolerance. In some embodiments, the threshold values T3 and T4 can be voltage values between and including about 0V and about 3.5V, including integer and non-integer values therebetween.

In some embodiments, an input S3 from the sensor assembly 84 at or less than the threshold value T5 can indicate a condition in which one or both of the laser lines 17, 27 are tilted below a level condition with respect to the Z-axis, and an input S3 from the sensor assembly 84 at or greater than the threshold value T6 can indicate a condition in which one or both of the laser lines 17, 27 are tilted above a level condition with respective to the Z-axis.

In other embodiments, an input S3 from the sensor assembly 84 at or less than the threshold value T5 can indicate a condition in which one or both of the laser lines 17, 27 are tilted above a level condition with respect to the Z-axis, and an input S3 from the sensor assembly 84 at or greater than the threshold value T5 can indicate a condition in which one or both of the laser lines 17, 27 are tilted below a level condition with respective to the Z-axis.

If the input S3 from the sensor assembly 84 is such that T5<S3<T6 is false or no, the process can proceed to a step 318, in which control of the motor assembly 128 is effected, as described further herein.

However, if the input S3 from the sensor assembly 84 is such that T5<S3<T6 is true or yes, the control circuitry 130 can reach a determination at step 320 that the laser projectors 16, 26 and projected laser lines 17, 27 are level with regard to the X-, Y-, and Z-axes. It will be understood that such process can be repeated, for example, a predetermined number of cycles, based on the expiration of a timer, based on one or more user inputs, for example, via an I/O device 138, based on a sensor reading etc.

It will be understood that the foregoing steps 304-317 can occur simultaneously or in sequence, or that such sequences can occur in a different order without departing from the disclosure.

Referring additionally to FIG. 19A, control of the motor assembly 97 beginning at step 308 to correct an amount of tilt about the X-axis according to an exemplary embodiment of the disclosure is described in detail.

As shown, at the step 308, the control circuitry 130 energizes the motor 98 of the motor assembly 97 to rotate the lead screw 102 to drive the nut assembly 104 in the vertical direction V, either upwardly or downwardly as the case may be, to offset the tilt about the X-axis measured in step 306 (as determined by sensor assembly 80 when laser level assembly 10 is in the upright orientation, or by sensor assembly 82 if laser level assembly 10 is in the side laying orientation). As described above, the nut assembly 104 can travel along the vertical direction V1 such that a respective engagement pin 112, 114 can contact the compensation pin 62 and urge the downwardly depending arm 58 either upwardly or downwardly so as to cause the upper frame assembly 44 to pivot the ball 52 of the joint 48 about the X-axis, as indicated by the bi-directional arrow R_{X}.

Such control of the motor 98 of the motor assembly 97 by the control circuitry 130 can include driving the motor 98 at a maximum speed per a rated torque thereof, and can include signaling from the sensor assembly 80/82 that a voltage value associated with a position of the bubble 94 in the vial 92 has changed from a negative to a positive value (or a value below a predetermined threshold to a value above the predetermined threshold), and vice versa.

As shown, at a step 322, the control circuitry 130 can log an amount of time that the motor 98 of the motor assembly 97 has been driven after step 308, corresponding to a time value Q1.

The process can proceed to a step 324 in which the control circuitry 130 energizes the motor 98 of the motor assembly 97 to rotate the lead screw 102 in the direction V opposite that in the step 308 such that the nut assembly 104 travels in a vertical direction opposite the vertical direction V to effect counter-rotation of the ball 52 of the joint 48 about the X-axis. The control circuitry 130 can drive the lead screw 102 to rotate to effect travel of the nut assembly 104 about the vertical direction for a length of time proportional to the length of time Q1.

Once the motor assembly 97 has been driven according to step 324, the control circuitry 130 can pause a predetermined length of time to allow the bubble 94 in the vial 92 of the sensor assembly 80/82 to settle, e.g., due to inertia associated with the foregoing steps, before proceeding to a step 326. In some embodiments, the steps 308-324 can be associated with coarse control of the motor assembly 97.

With continued reference to FIG. 19A, in a step 326, the control circuitry 130 can receive an updated input signal S4 from the sensor assembly 80/82 indicative of a relative position of the bubble 94 in the vial 92 thereof.

In a step 328, the control circuitry 130 can determine whether the input signal S4 is less than a threshold value T7 or greater than a threshold value T8, again indicating a condition in which one or both of the laser projectors 16, 26 are not level about the X-axis. The threshold values T7 and T8 can represent a narrower threshold than the threshold values T1 and T2 to which the input signal S1 was compared in step 306, such that T1<T7<T8<T2. In some embodiments, the threshold values T7 and T8 can be voltage values between and including about 0.25V and about 3.25V, including integer and non-integer values therebetween.

If the input S4 from the sensor assembly 80/82 is such that T7<S4<T8 is false or no, the process can proceed to a step 330, in which further control of the motor assembly 97 is effected, as described further herein. However, if the input S4 from the sensor assembly 80/82 is such that T7<S4<T8 is true or yes, the process can bypass the step 328 and proceed to a step 334.

At the step 330, the control circuitry 130 can energize the motor 98 of the motor assembly 97 to rotate the lead screw 102 to drive the nut assembly 104 in the vertical direction V, upwardly or downwardly as the case may be, to offset the tilt about the X-axis as determined by the control circuitry 130 from the step 328.

As described above, the nut assembly 104 can travel along the vertical direction V such that a respective engagement pin 112, 114 can contact the compensation pin 62 and urge the downwardly depending arm 58 downwardly so as to cause the upper frame assembly 44 to pivot the ball 52 of the joint 48 about the X-axis, as indicated by the bi-directional arrow R_{X}.

Such control of the motor 98 of the motor assembly 97 by the control circuitry 130 can include driving the motor 98 under step control at a predetermined number of steps. Such step control of the motor 98 can include periodic pauses to allow the bubble 94 to settle in the vial 92 of the sensor assembly 80/82. In some embodiments, the driving of the motor 98 can also include intermittent or constant feedback from the sensor assembly 80/82 until the control circuitry 130 determines that a value from the sensor assembly 80/82 is between T7 and T8.

Proceeding to a step 332, the control circuitry 130 can receive an updated input signal S5 from the sensor assembly 80/82 indicative of a relative position of the bubble 94 in the vial 92 thereof. The control circuitry 130 can determine whether the input signal S5 is greater than a threshold value T9 or less than a threshold value T10, again indicating a condition in which one or both of the laser projectors 16, 26 and projected lines 17, 27 are not level about the X-axis. The threshold values T9 and T10 can represent a narrower threshold than the threshold values T7 and T8 to which the input signal S4 was compared in step 352, such that T1<T7<T9<T10<T8<T2. In some embodiments, the threshold values T9 and T10 can be voltage values between and including about 1.5V and about 2V, such as between and including about 1.6V and about 1.9V, between and including about 1.7V and about 1.8V, and non-integer values therebetween.

If the input S5 from the sensor assembly 80/82 is such that T9<S5<T10 is false or no, the process can proceed to a step 336, in which further control of the motor assembly 97 is effected, as described further herein. However, if the input S5 from the sensor assembly 80 is such that T9<S5<T10 is true or yes, the process can revert to step 310 (FIG. 18).

At the step 336, the control circuitry 130 can calculate a motor driving signal for the motor 98 of the motor assembly 97 needed to achieve a level position of the laser projectors 16, 26 and projected lines 17, 27 about the X-axis, e.g., so as to achieve a position of tilt of the upper frame assembly 44 about the joint 48 in the direction of the arrow R_{X}.

Such determination of the proper motor driving signal at step 336 can be based on one or more of the input S5, an intermittently or updated signal received from the sensor assembly 80/82, one or more inter axial factors (wherein a motor driving a particular degree of freedom effects residual motion in other degrees of freedom), and/or relative comparisons to the threshold values T9 and T10. In instances in which updated signals from the sensor assembly 80/82 are received by the control circuitry 130 on an updated basis, intermittent pauses associated with allowing the bubble 94 to settle in the vial 92 of the sensor assembly 80/82 can punctuate such signaling.

Once the proper motor driving signal at step 336 is determined by the control circuitry 130, the process can proceed to a step 338 in which the control circuitry 130 energizes the motor 98 of the motor assembly 97 to rotate the lead screw 102 to drive the nut assembly 104 in the vertical direction V, either upwardly or downwardly as the case may be, to offset the tilt about the X-axis. Accordingly, the nut assembly 104 can travel along the vertical direction V such that a respective engagement pin 112, 114 can contact the compensation pin 62 and urge the downwardly depending arm 58 upwardly or downwardly so as to cause the upper frame assembly 44 to pivot the ball 52 of the joint 48 about the X-axis, as indicated by the bi-directional arrow R_{X}.

Such control of the motor 98 of the motor assembly 97 by the control circuitry 130 can include driving the motor 98 under step control at a number of steps determined by the control circuitry 130 in step 336. Such step control of the motor 98 can include periodic pauses to allow the bubble 94 to settle in the vial 92 of the sensor assembly 80/82.

Proceeding to a step 340, the control circuitry 130 can measure an updated input S5′ from the sensor assembly 80/82, and the control circuitry 130 can determine whether S5′ is within a threshold such that T9<S5′<T10 at a step 342.

If the control circuitry 130 determines that T9<S5′<T10 is true or yes at step 342, the process can revert to step 310 (FIG. 18). If, however, the control circuitry 130 determines at step 344 that T9<S5′<T10 is false or no, the process can revert to step 336 for further motor driving of the motor assembly 97.

In one embodiment, one or more of the tuning steps 330-342 of FIG. 19A for actively leveling the laser projectors 16, 26 of the laser level assembly 10 may be described as shown in FIG. 19B. To correct the amount of tilt about the X-axis the control circuitry may set the desired target range between T9 and T10. Control circuitry 130 can determine whether S4 is within a threshold such that T9<S4<T10. A feedback loop may then be implemented as shown involving incrementally driving the motor 98 according to intermediate measured input S_{A} from the sensor assembly 80 to update input S4′. The feedback loop may continue to tune the tilt about the X-axis until the condition T9<S4′<T10 is met.

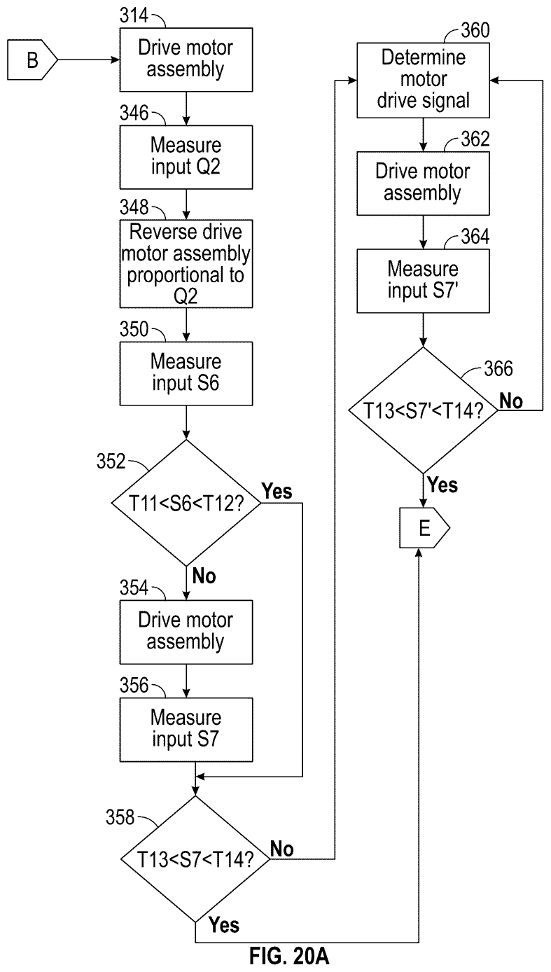

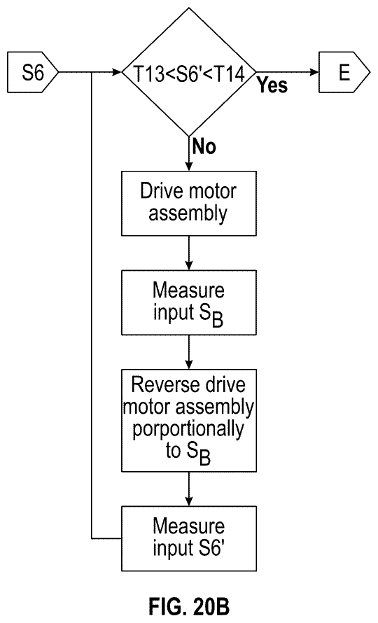

Referring additionally to FIG. 20A, control of the motor assembly 126, beginning at step 314, to correct an amount of tilt about the Y-axis when laser level assembly 10 is in the upright orientation according to an exemplary embodiment of the disclosure is described in detail.

As shown, at the step 314, the control circuitry 130 energizes the motor 98 of the motor assembly 126 to rotate the lead screw 102 to drive the nut assembly 104 in the vertical direction V, either upwardly or downwardly as the case may be, to offset the tilt about the Y-axis measured in step 312. As described above, the nut assembly 104 can travel along the vertical direction V such that a respective engagement pin 112, 114 can contact the compensation pin 70 and urge the downwardly depending arm 64 either upwardly or downwardly, as the case may be, so as to cause the upper frame assembly 44 to pivot the ball 52 of the joint 48 about the Y-axis, as indicated by the bi-directional arrow R_{Y}.

Such control of the motor 98 of the motor assembly 126 by the control circuitry 130 can include driving the motor 98 at a maximum speed per a rated torque thereof, and can include signaling from the sensor assembly 84 that a voltage value associated with a position of the bubble 94 in the vial 92 has changed from a negative to a positive value (or a value below a predetermined threshold to a value above the predetermined threshold), and vice versa.

As shown, at a step 346, the control circuitry 130 can log an amount of time that the motor 98 of the motor assembly 126 has been driven after step 314, corresponding to a time value Q2.

The process can proceed to a step 348 in which the control circuitry 130 energizes the motor 98 of the motor assembly 126 to rotate the lead screw 102 in the direction V opposite that in the step 314 such that the nut assembly 104 travels in a vertical direction opposite the vertical direction V to effect counter-rotation of the ball 52 of the joint 48 about the Y-axis. The control circuitry 130 can drive the lead screw 102 to rotate to effect travel of the nut assembly 104 about the vertical direction V for a length of time proportional to the length of time Q2.

Once the motor assembly 126 has been driven according to step 348, the control circuitry 130 can pause a predetermined length of time to allow the bubble 94 in the vial 92 of the sensor assembly 84 to settle, e.g., due to inertia associated with the foregoing steps, before proceeding to a step 350. In some embodiments, the steps 314-348 can be associated with coarse control of the motor assembly 97.

With continued reference to FIG. 20A, in a step 350, the control circuitry 130 can receive an updated input signal S6 from the sensor assembly 84 indicative of a relative position of the bubble 94 in the vial 92 thereof.

In a step 352, the control circuitry 130 can determine whether the input signal S6 is greater than a threshold value T11 or less than a threshold value T12, again indicating a condition in which one or both of the laser projectors 16, 26 are not level about the Y-axis. The threshold values T11 and T12 can represent a narrower threshold than the threshold values T3 and T4 to which the input signal S2 was compared in step 312, such that T3<T11<T12<T4. In some embodiments, the threshold values T11 and T12 can be voltage values between and including about 0.25V and about 3.25V, including integer and non-integer values therebetween.

If the input S6 from the sensor assembly 84 is such that T1<S6<T12 is false or no, the process can proceed to a step 354, in which further control of the motor assembly 126 is effected, as described further herein. However, if the input S6 from the sensor assembly 126 is such that T1<S6<T12 is true or yes, the process can bypass the step 354 and proceed to a step 358.

At the step 354, the control circuitry 130 can energize the motor 98 of the motor assembly 126 to rotate the lead screw 102 to drive the nut assembly 104 in the vertical direction V, upwardly or downwardly as the case may be, to offset the tilt about the Y-axis as determined by the control circuitry 130 from the step 352.

As described above, the nut assembly 104 can travel along the vertical direction V such that a respective engagement pin 112, 114 can contact the compensation pin 70 and urge the downwardly depending arm 64 upwardly or downwardly so as to cause the upper frame assembly 44 to pivot the ball 52 of the joint 48 about the Y-axis, as indicated by the bi-directional arrow R_{Y}.

Such control of the motor 98 of the motor assembly 126 by the control circuitry 130 can include driving the motor 98 under step control at a predetermined number of steps. Such step control of the motor 98 can include periodic pauses to allow the bubble 94 to settle in the vial 92 of the sensor assembly 84. In some embodiments, the driving of the motor 98 can also include intermittent or constant feedback from the sensor assembly 84 until the control circuitry 130 determines that a value from the sensor assembly 84 is between T11 and T12.

Proceeding to a step 356, the control circuitry 130 can receive an updated input signal S7 from the sensor assembly 84 indicative of a relative position of the bubble 94 in the vial 92 thereof. The control circuitry 130 can determine whether the input signal S7 is greater than a threshold value T13 or less than a threshold value T14, again indicating a condition in which one or both of the laser projectors 16, 26 and projected lines 17, 27 are not level about the Y-axis.

The threshold values T13 and T14 can represent a narrower threshold than the threshold values T11 and T12 to which the input signal S6 was compared in step 352, such that T3<T11<T13<T14<T12<T4. In some embodiments, the threshold values T13 and T14 can be voltage values between and including about 1.5V and about 2V, such as between and including about 1.6V and about 1.9V, between and including about 1.7V and about 1.8V, and non-integer values therebetween.

If the input S7 from the sensor assembly 84 is such that T13<S7<T14 is false or no, the process can proceed to a step 360, in which further control of the motor assembly 126 is effected, as described further herein. If, however, the input S7 is within the threshold such that T13<S7<T14 is true or yes, the process can revert to step 316 (FIG. 18).

At the step 360, the control circuitry 130 can calculate a motor driving signal for the motor 98 of the motor assembly 126 needed to achieve a level position of the laser projectors 16, 26 and projected lines 17, 27 about the Y-axis when the laser level assembly 10 is in the upright orientation, e.g., so as to achieve a position of tilt of the upper frame assembly 44 about the joint 48 in the direction of the arrow R_{Y}.

Such determination of the proper motor driving signal at step 360 can be based on one or more of the input S7, an intermittently or updated signal received from the sensor assembly 84, one or more inter axial factors, and relative comparisons to the threshold values T13 and T14. In instances in which updated signals from the sensor assembly 84 are received by the control circuitry 130 on an updated basis, intermittent pauses associated with allowing the bubble 94 to settle in the vial 92 of the sensor assembly 84 can punctuate such signaling.

Once the proper motor driving signal at step 360 is determined by the control circuitry 130, the process can proceed to a step 362 in which the control circuitry 130 energizes the motor 98 of the motor assembly 126 to rotate the lead screw 102 to drive the nut assembly 104 in the vertical direction V, either upwardly or downwardly as the case may be, to offset the tilt about the Y-axis. Accordingly, the nut assembly 104 can travel along the vertical direction V such that a respective engagement pin 112, 114 can contact the compensation pin 70 and urge the downwardly depending arm 64 upwardly or downwardly so as to cause the upper frame assembly 44 to pivot the ball 52 of the joint 48 about the Y-axis, as indicated by the bi-directional arrow R_{Y}.

Such control of the motor 98 of the motor assembly 126 by the control circuitry 130 can include driving the motor 98 under step control at a number of steps determined by the control circuitry 130 in step 360. Such step control of the motor 98 can include periodic pauses to allow the bubble 94 to settle in the vial 92 of the sensor assembly 84.

Proceeding to a step 364, the control circuitry 130 can measure an updated input S7′ from the sensor assembly 82 to determine whether S7′ is within a threshold such that T13<S7′<T14.

If the control circuitry 130 determines that T13>S7′>T14 is true or yes, the process can revert to step 317 (FIG. 18). If, however, the control circuitry 130 determines at step 366 that T13<S7′<T14 is false or no, the process can revert to step 360 for further motor driving of the motor assembly 126.

In one embodiment, one or more of the tuning steps 352-366 of FIG. 20A for actively leveling the laser projectors 16, 26 of the laser level assembly 10 may be described as shown in FIG. 20B. To correct the amount of tilt about the Y-axis the control circuitry may set the desired target range between T13 and T14. Control circuitry 130 can determine whether S6 is within a threshold such that T13<S6<T14. A feedback loop may then involve incrementally driving the motor 98 according to intermediate measured input SB from the sensor assembly 84 to update input S6′. The feedback loop may continue to tune the tilt about the Y-axis until the condition T13<S6′<T14 is met.

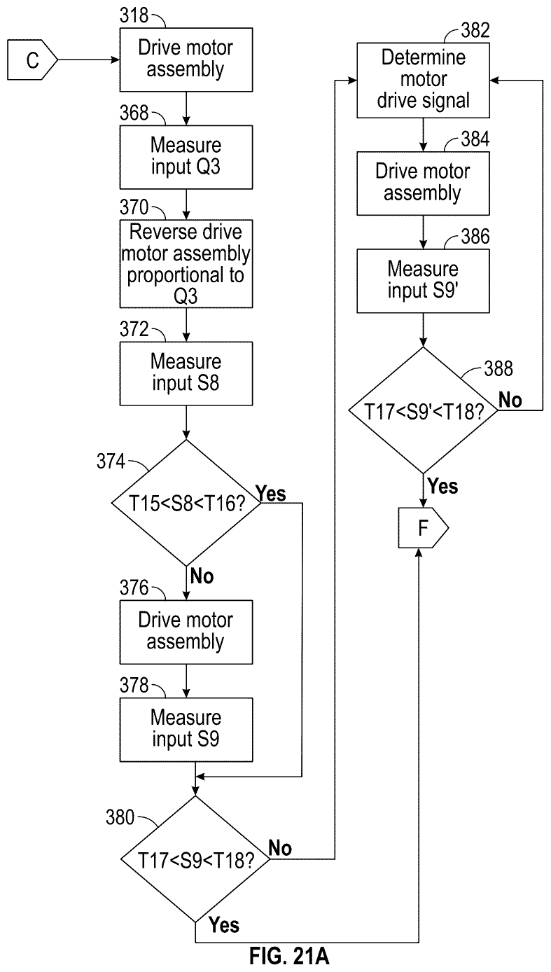

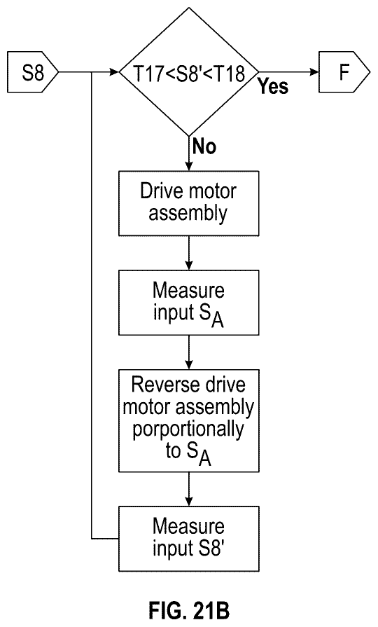

Referring additionally to FIG. 21A, control of the motor assembly 128, beginning at step 318, to correct an amount of tilt about the Z-axis when the laser level assembly 10 is in the side laying orientation according to an exemplary embodiment of the disclosure is described in detail.

As shown, at the step 318, the control circuitry 130 energizes the motor 98 of the motor assembly 128 to rotate the lead screw 102 to drive the nut assembly 104 in the horizontal direction H, either left or right as the case may be, to offset the tilt about the Z-axis measured in step 317. As described above, the nut assembly 104 can travel along the horizontal direction H such that a respective engagement pin 112, 114 can contact the compensation pin 60 and urge the downwardly depending arm 56 either left or right, as the case may be, so as to cause the upper frame assembly 44 to pivot the ball 52 of the joint 48 about the Z-axis, as indicated by the bi-directional arrow R_{Z}.

Such control of the motor 98 of the motor assembly 128 by the control circuitry 130 can include driving the motor 98 at a maximum speed per a rated torque thereof, and can include signaling from the sensor assembly 84 that a voltage value associated with a position of the bubble 94 in the vial 92 has changed from a negative to a positive value (or a value below a predetermined threshold to a value above the predetermined threshold), and vice versa.

As shown, at a step 368, the control circuitry 130 can log an amount of time that the motor 98 of the motor assembly 128 has been driven after step 318, corresponding to a time value Q3.

The process can proceed to a step 370 in which the control circuitry 130 energizes the motor 98 of the motor assembly 128 to rotate the lead screw 102 in the direction H opposite that in the step 318 such that the nut assembly 104 travels in a vertical direction opposite the horizontal direction H to effect counter-rotation of the ball 52 of the joint 48 about the Z-axis. The control circuitry 130 can drive the lead screw 102 to rotate to effect travel of the nut assembly 104 about the horizontal direction H for a length of time proportional to the length of time Q3.

Once the motor assembly 128 has been driven according to step 370, the control circuitry 130 can pause a predetermined length of time to allow the bubble 94 in the vial 92 of the sensor assembly 84 to settle, e.g., due to inertia associated with the foregoing steps, before proceeding to a step 372. In some embodiments, the steps 318-370 can be associated with coarse control of the motor assembly 97.

With continued reference to FIG. 21A, in a step 372, the control circuitry 130 can receive an updated input signal S8 from the sensor assembly 84 indicative of a relative position of the bubble 94 in the vial 92 thereof.

In a step 374, the control circuitry 130 can determine whether the input signal S8 is greater than a threshold value T15 or less than a threshold value T16, again indicating a condition in which one or both of the laser projectors 16, 26 are not level about the Z-axis. The threshold values T16 and T17 can represent a narrower threshold than the threshold values T5 and T6 to which the input signal S3 was compared in step 317, such that T5<T15<T16<T6. In some embodiments, the threshold values T15 and T16 can be voltage values between and including about 0.25V and about 3.25V, including integer and non-integer values therebetween.

If the input S8 from the sensor assembly 82 is such that T15<S8<T16 is false or no, the process can proceed to a step 376, in which further control of the motor assembly 128 is effected, as described further herein. However, if the input S8 from the sensor assembly 84 is such that T15<S8<T16 is true or yes, the process can bypass the step 376 and proceed to a step 380.

At the step 376, the control circuitry 130 can energize the motor 98 of the motor assembly 128 to rotate the lead screw 102 to drive the nut assembly 104 in the horizontal direction H, upwardly or downwardly as the case may be, to offset the tilt about the Z-axis as determined by the control circuitry 130 from the step 374.

As described above, the nut assembly 104 can travel along the horizontal direction H such that a respective engagement pin 112, 114 can contact the compensation pin 60 and urge the downwardly depending arm 56 left or right so as to cause the upper frame assembly 44 to pivot the ball 52 of the joint 48 about the Z-axis, as indicated by the bi-directional arrow R_{Z}.

Such control of the motor 98 of the motor assembly 128 by the control circuitry 130 can include driving the motor 98 under step control at a predetermined number of steps. Such step control of the motor 98 can include periodic pauses to allow the bubble 94 to settle in the vial 92 of the sensor assembly 84. In some embodiments, the driving of the motor 98 can also include intermittent or constant feedback from the sensor assembly 84 until the control circuitry 130 determines that a value from the sensor assembly 84 is between T15 and T16.

Proceeding to a step 378, the control circuitry 130 can receive an updated input signal S9 from the sensor assembly 84 indicative of a relative position of the bubble 94 in the vial 92 thereof. The control circuitry 130 can determine whether the input signal S9 is greater than a threshold value T17 or less than a threshold value T18, again indicating a condition in which one or both of the laser projectors 16, 26 and projected lines 17, 27 are not level about the Z-axis.

The threshold values T17 and T18 can represent a narrower threshold than the threshold values T15 and T16 to which the input signal S8 was compared in step 374, such that T5<T15<T17<T18<T16<T6. In some embodiments, the threshold values T15 and T16 can be voltage values between and including about 1.5V and about 2V, such as between and including about 1.6V and about 1.9V, between and including about 1.7V and about 1.8V, and non-integer values therebetween.

If the input S9 from the sensor assembly 84 is such that T17<S9<T18 is false or no, the process can proceed to a step 382, in which further control of the motor assembly 128 is effected, as described further herein. If, however, the input S9 is within the threshold such that T17<S9<T18 is true or yes, the process can revert to step 320.

At the step 382, the control circuitry 130 can calculate a motor driving signal for the motor 98 of the motor assembly 128 needed to achieve a level position of the laser projectors 16, 26 and projected lines 17, 27 about the Z-axis, e.g., so as to achieve a position of tilt of the upper frame assembly 44 about the joint 48 in the direction of the arrow R_{Z}.

Such determination of the proper motor driving signal at step 382 can be based on one or more of the input S9, an intermittently or updated signal received from the sensor assembly 82, one or more inter axial factors, and relative comparisons to the threshold values T15 and T16. In instances in which updated signals from the sensor assembly 84 are received by the control circuitry 130 on an updated basis, intermittent pauses associated with allowing the bubble 94 to settle in the vial 92 of the sensor assembly 84 can punctuate such signaling.

Once the proper motor driving signal at step 382 is determined by the control circuitry 130, the process can proceed to a step 384 in which the control circuitry 130 energizes the motor 98 of the motor assembly 126 to rotate the lead screw 102 to drive the nut assembly 104 in the horizontal direction H, either upwardly or downwardly as the case may be, to offset the tilt about the Z-axis.

Accordingly, the nut assembly 104 can travel along the horizontal direction H such that a respective engagement pin 112, 114 can contact the compensation pin 60 and urge the downwardly depending arm 56 left or right so as to cause the upper frame assembly 44 to pivot the ball 52 of the joint 48 about the Z-axis, as indicated by the bi-directional arrow R_{Z}.

Such control of the motor 98 of the motor assembly 128 by the control circuitry 130 can include driving the motor 98 under step control at a number of steps determined by the control circuitry 130 in step 382. Such step control of the motor 98 can include periodic pauses to allow the bubble 94 to settle in the vial 92 of the sensor assembly 84.

Proceeding to a step 386, the control circuitry 130 can measure an updated input S9′ from the sensor assembly 82 to determine whether S9′ is within a threshold such that T17<S9′<T18.

If the control circuitry 130 determines at a step 388 that T17<S9′<T18 is true or yes, the process can revert to step 320 (FIG. 18). If, however, the control circuitry 130 determines at step 388 that T15<S9′<T16 is false or no, the process can revert to step 382 for further motor driving of the motor assembly 128.

In one embodiment, one or more of the tuning steps 374-388 of FIG. 21A for actively leveling the laser projectors 16, 26 of the laser level assembly 10 may be described as shown in FIG. 21B. To correct the amount of tilt about the Z-axis the control circuitry may set the desired target range between T17 and T18. Control circuitry 130 can determine whether S8 is within a threshold such that T18<S8<T18. A feedback loop may then involve incrementally driving the motor 98 according to intermediate measured input SB from the sensor assembly 84 to update input S8′. The feedback loop may continue to tune the tilt about the Y-axis until the condition T13<S8′<T14 is met.

It will be understood that, in the course of the foregoing control of the motor assemblies 97, 126, 128 to effect leveling of the upper frame assembly 44 and associated components about the X-, Y-, and Z-axes in coordination with the respective sensor assemblies 82, 80, 84, control by the control circuitry 130 of each and every motor assembly 97, 126, 128 may not always be needed depending on the orientation of the laser level assembly 10.

For example, when the laser level assembly 10 is in the upright orientation, the laser level assembly 10, laser generators 16, 26, and associated laser lines 17, 27 may be leveled about the Z-axis so as to obviate a desire for any leveling about the Z-axis. However, in some embodiments, a user may optionally choose to manually adjust the upper frame assembly 44 and laser generators 16, 26 supported thereon about the Z-axis, for example, with the I/O device 138.

As another example, when the laser level assembly 10 is in the side laying orientation, the laser level assembly 10, laser generators 16, 26, and associated laser lines 17, 27 may be leveled about the Y-axis so as to obviate a desire for any leveling about the Y-axis. However, in some embodiments, a user may optionally choose to manually adjust the upper frame assembly 44 and laser generators 16, 26 supported thereon about the Y-axis, for example, with the I/O device 138.

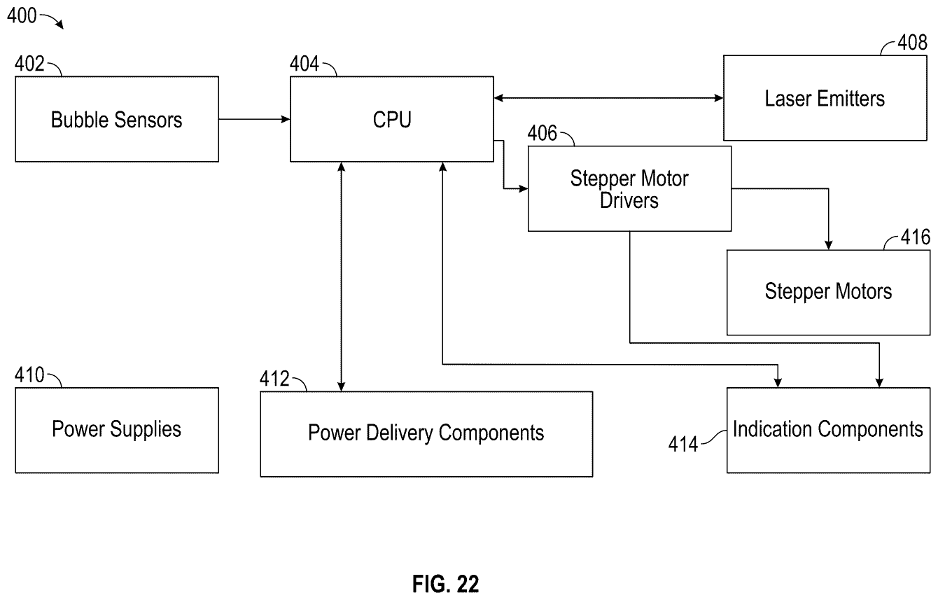

FIG. 22 is a block diagram illustrating an exemplary architecture for an electronics system 400 that may be used with one or more of the described embodiments. For example, the system 400 may represent any data processing system (e.g., one or more of the systems described above performing any of the operations, control, or methods described above in connection with the figures, etc.). The system 400 can include multiple components that can be implemented as integrated circuits (ICs), portions thereof, discrete electronic devices, or other modules adapted to a circuit board such as a motherboard or add-in card of a computer system, or as components otherwise incorporated within a chassis of a computer system. Note also that system 400 is intended to show a high-level view of many, but not all, components of the computer system. Nevertheless, it is to be understood that additional components may be present in certain implementations and furthermore, different arrangements of the components shown may occur in other implementations. The system 400 may represent a desktop computer system, a laptop computer system, a tablet computer system, a server computer system, a mobile phone, a media player, a personal digital assistant (PDA), a personal communicator, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute instructions to perform any of the methodologies discussed herein.

For one embodiment, the system 400 includes the bubble sensors 402, one or more central processing units (CPU) 404, stepper motor driver(s) 406, laser emitters 408, one or more power supplies 410 (different components of the laser level assembly 10 may have different voltage requirements), power delivery components 412, indication components 414, and the stepper motors 416 for the active leveling process. Similar to the control circuitry described earlier herein, the system 400 can also include a network, and the processor(s) of the one or more CPUs 404 can represent a single processor or multiple processors with a single processor core or multiple processor cores included therein. For example, the one or more CPUs 404 may be a complex instruction set computer (CISC), a reduced instruction set computer (RISC) or a very long instruction word (VLIW) computer architecture processor, or processors implementing a combination of instruction sets.

In some embodiments, the one or more CPUs 404 may communicate with memory (not shown), which can be implemented via multiple memory devices to provide for a given amount of system memory. Memory can include one or more volatile storage (or memory) devices such as random access memory (RAM), dynamic RAM (DRAM), synchronous DRAM (SDRAM), static RAM (SRAM), or other types of storage devices. Memory may store information including sequences of instructions that are executed by the CPUs or any other device (e.g., responding to signals from the bubble sensors 402 to drive the stepper motors 416 to perform the algorithms shown in FIGS. 17-21 to level the laser emitters 408).

In view of the foregoing, a laser level assembly 10 is provided with two perpendicularly-extending line laser generators 16, 26 and reorientable between an upright orientation, in which a horizontal laser line and a vertical laser line can be provided, and a side laying orientation, in which perpendicular vertical laser lines can be provided. The laser level assembly 10 is further provided with active leveling features for truing or leveling such laser lines with respect to a frame of reference, which in some such frame of reference can be that in which a downward direction is determined by the influence of gravity.

Accordingly, the laser level assembly 10 provides a versatile laser line generating device capable of providing accurately leveled guide lines along three parallel axes in a compact configuration.

It will be understood that one or more components of the laser level assembly 10 and associated features can be differently configured without departing from the disclosure.

The foregoing description of the disclosure illustrates and describes various exemplary embodiments. Various additions, modifications, changes, etc., could be made to the exemplary embodiments without departing from the spirit and scope of the disclosure. It is intended that all matter contained in the above description or shown in the accompanying drawings shall be interpreted as illustrative and not in a limiting sense. Additionally, the disclosure shows and describes only selected embodiments of the disclosure, but the disclosure is capable of use in various other combinations, modifications, and environments and is capable of changes or modifications within the scope of the inventive concept as expressed herein, commensurate with the above teachings, and/or within the skill or knowledge of the relevant art. Furthermore, certain features and characteristics of each embodiment may be selectively interchanged and applied to other illustrated and non-illustrated embodiments of the disclosure.

What is claimed is:

1. A laser leveling apparatus, comprising:
a housing extending at least partially around an interior of the laser leveling apparatus;
a first laser generator extending at least partially through the housing and configured to project a first laser line when activated;
a second laser generator extending at least partially through the housing and configured to project a second laser line perpendicular to the first laser line when activated such that the laser leveling apparatus is reorientable between an upright position, in which the first laser generator extends upwardly from the housing and the second laser generator extends outwardly from the housing, and a side lying position, in which the first laser generator extends outwardly from the housing and the second laser generator extends upwardly from the housing;
an active leveling platform assembly positioned in the interior of the laser leveling apparatus, the active leveling platform assembly comprising:
an upper frame assembly pivotably mounted to a lower frame assembly, the first laser generator and the second laser generator supported on the upper frame assembly;
a first motor assembly operably coupled to the upper frame assembly;
a second motor assembly operably coupled to the upper frame assembly;
a third motor assembly operably coupled to the upper frame assembly;
a first sensor assembly in electronic communication with the first motor assembly;
a second sensor assembly in electronic communication with the second motor assembly; and
a third sensor assembly in electronic communication with the third motor assembly; and
control circuitry configured to:
activate the first motor assembly to tilt the upper frame assembly relative to the lower frame assembly about a first axis based on one or more signals from the first sensor assembly;
activate the second motor assembly to tilt the upper frame assembly relative to the lower frame assembly about a second axis based on one or more signals from the second sensor assembly; and
activate the third motor assembly to tilt the upper frame assembly relative to the lower frame assembly about a third axis based on one or more signals from the third sensor assembly,
the first axis is perpendicular to each of the second axis and the third axis, and the second axis is perpendicular to the third axis.

2. The laser leveling apparatus of claim 1, wherein the first laser generator and the second laser generator each comprise a respective line laser module.

3. The laser leveling apparatus of claim 2, wherein the control circuitry is configured to drive each of the first motor assembly and the second motor assembly along a direction parallel to the third axis to tilt the upper frame assembly relative to the respective first axis and second axis.

4. The laser leveling apparatus of claim 3, wherein the control circuitry is configured to drive the third motor assembly along a direction parallel to one of the first axis and the second axis to tilt the upper frame assembly about the third axis.

5. The laser leveling apparatus of claim 4, wherein the upper frame assembly of the active leveling platform assembly is pivotably mounted to the lower frame assembly of the active leveling platform assembly on a ball joint.

6. The laser leveling apparatus of claim 5, wherein at least one of the first sensor assembly, the second sensor assembly, and the third sensor assembly comprises a bubble level.

7. An active leveling platform assembly for a laser leveling apparatus, the active leveling platform assembly comprising:
an upper frame assembly pivotably mounted to a lower frame assembly, a first laser generator and a second laser generator supported on the upper frame assembly;
a first motor assembly operably coupled to the upper frame assembly;
a second motor assembly operably coupled to the upper frame assembly;
a third motor assembly operably coupled to the upper frame assembly;
a first sensor assembly in electronic communication with the first motor assembly;
a second sensor assembly in electronic communication with the second motor assembly; and
a third sensor assembly in electronic communication with the third motor assembly;
control circuitry configured to:
activate the first motor assembly to tilt the upper frame assembly relative to the lower frame assembly about a first axis based on one or more signals from the first sensor assembly;
activate the second motor assembly to tilt the upper frame assembly relative to the lower frame assembly about a second axis based on one or more signals from the second sensor assembly; and
activate the third motor assembly to tilt the upper frame assembly relative to the lower frame assembly about a third axis based on one or more signals from the third sensor assembly,
the first axis is perpendicular to each of the second axis and the third axis, and the second axis is perpendicular to the third axis.

8. The active leveling platform assembly of claim 7, wherein the first laser generator and the second laser generator each comprise a respective line laser module.

9. The active leveling platform assembly of claim 8, wherein the control circuitry is configured to drive each of the first motor assembly and the second motor assembly along a direction parallel to the third axis to tilt the upper frame assembly relative to the respective first axis and second axis.

10. The active leveling platform assembly of claim 9, wherein the control circuitry is configured to drive the third motor assembly along a direction parallel to one of the first axis and the second axis to tilt the upper frame assembly about the third axis.

11. The active leveling platform assembly of claim 10, wherein the upper frame assembly of the active leveling platform assembly is pivotably mounted to the lower frame assembly of the active leveling platform assembly on a ball joint.

12. The active leveling platform assembly of claim 11, wherein at least one of the first sensor assembly, the second sensor assembly, and the third sensor assembly comprises a bubble level.

13. A method of assembling an active leveling platform assembly for a laser leveling apparatus, the method comprising;
pivotably mounting an upper frame assembly to a lower frame assembly;
mounting a first laser generator on the upper frame assembly;
mounting a second laser generator on the upper frame assembly;
operably coupling a first motor assembly to the upper frame assembly;
operably coupling a second motor assembly to the upper frame assembly;
operably coupling a third motor assembly to the upper frame assembly;
positioning a first sensor assembly in electronic communication with the first motor assembly;
positioning a second sensor assembly in electronic communication with the second motor assembly;
positioning a third sensor assembly in electronic communication with the third motor assembly; and
placing the first motor assembly, the second motor assembly, the third motor assembly, the first sensor assembly, the second sensor assembly, and the third sensor assembly in electronic communication with control circuitry such that the first motor assembly is configured to tilt the upper frame assembly relative to the lower frame assembly about a first axis based on one or more signals from the first sensor assembly, such that the second motor assembly is configured to tilt the upper frame assembly relative to the lower frame assembly about a second axis based on one or more signals from the second sensor assembly, and such that the third motor assembly is configured to tilt the upper frame assembly relative to the lower frame assembly about a third axis based on one or more signals from the third sensor assembly,
the first axis perpendicular to each of the second axis and the third axis, the second axis perpendicular to the third axis.

14. The method of claim 13, wherein the first laser generator and the second laser generator each comprise a respective line laser module.

15. The method of claim 14, wherein the control circuitry is configured to drive each of the first motor assembly and the second motor assembly along a direction parallel to the third axis to tilt the upper frame assembly relative to the respective first axis and second axis.

16. The method of claim 15, wherein the control circuitry is configured to drive the third motor assembly along a direction parallel to one of the first axis and the second axis to tilt the upper frame assembly about the third axis.

17. The method of claim 16, wherein the upper frame assembly of the active leveling platform assembly is pivotably mounted to the lower frame assembly of the active leveling platform assembly on a ball joint.

18. The method of claim 17, wherein at least one of the first sensor assembly, the second sensor assembly, and the third sensor assembly comprises a bubble level.
